(19) United States
(12) Patent Application Publication
(10) Pub. No.: US 2026/0312651 A1
(43) Pub. Date: Oct. 8, 2026

(54) METHOD AND APPARATUS FOR DETERMINING DOWNLINK PRECODER WITH NON-ORTHOGONAL BASIS IN MOBILE COMMUNICATIONS

(71) Applicant: MediaTek Singapore Pte. Ltd., Singapore (SG)

(72) Inventors: Goraknath Guptha VISANAKARRA, Bengaluru (IN); Jinesh Parameshwaran NAIR, Bengaluru (IN); Chin-Kuo JAO, Hsinchu City (TW); Tzu-Han CHOU, San Jose, CA (US); Sandeep BHAT, Bengaluru (IN); Jiann-Ching GUEY, Hsinchu City (TW); Chia-Hao YU, Hsinchu City (TW)

(21) Appl. No.: 19/489,382

(22) PCT Filed: May 31, 2024
(86) PCT No.: PCT/CN2024/096546

§ 371 Date: Dec. 2, 2025

(30) Foreign Application Priority Data
Jun. 2, 2023 (IN) 202321037926

(51) Int. Cl. H04B 7/06; H04W 76/20

(52) U.S. Cl. CPC H04B 7/0626; H04B 7/0634; H04W 76/20

(57) ABSTRACT

Various solutions for downlink (DL) precoder construction with non-orthogonal basis with respect to an apparatus in mobile communications are described. The apparatus may transmit a configuration to a user equipment (UE) for the UE to determine a channel state information (CSI) report including information of a plurality of non-orthogonal basis vectors with a plurality of oversampling factors. The apparatus may receive the CSI report from the UE. The apparatus may determine a precoder for data transmission according to the information of the plurality of non-orthogonal basis vectors with the plurality of oversampling factors.

### CROSS REFERENCE TO RELATED PATENT APPLICATION(S)

The present disclosure is part of a non-provisional application claiming the priority benefit of India application No. 202321037926, filed 2 Jun. 2023, the content of which herein being incorporated by reference in its entirety.

### TECHNICAL FIELD

The present disclosure is generally related to mobile communications and, more particularly, to downlink precoder construction with non-orthogonal basis with respect to apparatus in mobile communications.

### BACKGROUND

Unless otherwise indicated herein, approaches described in this section are not prior art to the claims listed below and are not admitted as prior art by inclusion in this section.

In 5^{th} generation (5G) New Radio (NR) mobile communications, Channel State Information Reference Signal (CSI-RS) is a reference signal (RS) used in the downlink (DL) direction for the purpose of channel sounding and used to measure the characteristics of a radio channel so that it can use correct modulation, code rate, precoder, beam forming etc. User equipment (UE) uses these reference signals to measure the quality of the DL channel and reports the results in the uplink (UL) through the CSI reports. The network node sends CSI-RSs for measuring channel status information such as CSI-Reference Signal Receiving Power (RSRP), CSI-Reference Signal Receiving Quality (RSRQ) and CSI-Signal to Interference plus Noise Ratio (SINR) for mobility procedures. Specific instances of CSI-RSs can be configured for time/frequency tracking and mobility measurements. CSI feedback is the way of indicating certain reports by the UE to the network for indicating channel parameters for, e.g., dynamic scheduling purpose. CSI parameters are the quantities related to the state of a channel. The UE reports CSI parameters to the network node as feedback. The CSI feedback includes several parameters, such as the Channel Quality Indicator (CQI), the Precoding Matrix Indicator (PMI) with different codebook sets and the Rank Indicator (RI). The CSI feedback may also include parameters for indicating a CSI-RS resource (or CSI-RS resource set) based on which the CQI, PMI and RI are derived and reported. The UE uses the CSI-RS to measure the CSI feedback. Upon receiving the CSI parameters, the network node may schedule DL data transmissions (e.g., modulation scheme, code rate, number of transmission layers and MIMO precoding) accordingly.

In the current NR CSI framework, the CSI feedback involves reporting of spatial domain (SD) and per-multi-input multi-output (MIMO) layer frequency domain (FD) bases on which a precoder for data transmission is decomposed. However, the selected SD and FD bases are always orthogonal and using of these orthogonal bases causes higher compression error, which gradually degrades the system performance.

Accordingly, how to reduce the compression error caused by using orthogonal bases becomes an important issue in the newly developed wireless communication network. Therefore, there is a need to provide proper schemes to reduce the compression error caused by using orthogonal bases.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to downlink (DL) precoder construction with non-orthogonal basis with respect to apparatus in mobile communications.

In one aspect, a method may involve an apparatus transmitting a configuration to a user equipment (UE) for the UE to determine a channel state information (CSI) report including information of a plurality of non-orthogonal basis vectors with a plurality of oversampling factors. The method may also involve the apparatus receiving the CSI report from the UE. The method may further involve the apparatus determining a precoder for data transmission according to the information of the plurality of non-orthogonal basis vectors with the plurality of oversampling factors.

In one aspect, a method may involve an apparatus receiving a configuration from a network node. The method may also involve the apparatus determining a CSI report including information of a plurality of non-orthogonal basis vectors with a plurality of oversampling factors according to the configuration. The method may further involve the apparatus transmitting the CSI report to the network node for the network node to determine a precoder according to the information of the plurality of non-orthogonal basis vectors with the plurality of oversampling factors.

In one aspect, an apparatus may comprise a transceiver which, during operation, wirelessly communicates with at least one UE of a wireless network. The apparatus may also comprise a processor communicatively coupled to the transceiver. The processor, during operation, may perform operations comprising transmitting, via the transceiver, a configuration to the UE for the UE to determine a CSI report including information of a plurality of non-orthogonal basis vectors with a plurality of oversampling factors. The processor may also perform operations comprising receiving, via the transceiver, the CSI report from the UE. The processor may further perform operations comprising determining a precoder for data transmission according to the information of the plurality of non-orthogonal basis vectors with the plurality of oversampling factors.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising receiving, via the transceiver, configuration from the network node. The processor may also perform operations comprising determining a CSI report including information of a plurality of non-orthogonal basis vectors with a plurality of oversampling factors according to the configuration. The processor may further perform operations comprising transmitting, via the transceiver, the CSI report to the network node for the network node to determine a precoder according to the information of the plurality of non-orthogonal basis vectors with the plurality of oversampling factors.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a diagram depicting an example scenario under schemes in accordance with implementations of the present disclosure.

FIG. 9 is a diagram depicting an example scenario under schemes in accordance with implementations of the present disclosure.

FIG. 10 is a block diagram of an example communication system in accordance with an implementation of the present disclosure.

FIG. 11 is a flowchart of an example process in accordance with an implementation of the present disclosure.

FIG. 12 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to downlink (DL) precoder construction with non-orthogonal basis with respect to apparatus in mobile communications. According to the present disclosure, a number of possible solutions may be implemented separately or jointly. That is, although these possible solutions may be described below separately, two or more of these possible solutions may be implemented in one combination or another.

Regarding codebook configuration and precoder reporting of 3GPP Enhanced TypeII (eTypeII) precoder (i.e., codebook configuration and precoder reporting of 3GPP Release-16 eTypeII Precoder) under current channel state information (CSI) framework, a network may transmit a CSI-reference signal (CSI-RS) and request a user equipment (UE) to report Precoding Matrix Indicator (PMI) through downlink control information (DCI). The “CSI request” field in DCI may trigger an aperiodic CSI report whose configuration is present in the corresponding CSI-ReportConfig (which is information element in 3GPP specification) in a radio resource control (RRC) configuration. The CSI-ReportConfig in the RRC configuration may trigger a periodic CSI report or semi-persistent CSI report at pre-defined intervals from the UE.

The UE may measure the channel from the CSI-RS and form an appropriate precoder using some mathematical methods (e.g., singular value decomposition (SVD) etc.) The precoder may be compressed and reported according to the configuration present in CodebookConfig in the CSI-ReportConfig. The UE may use eTypeII Compression method described in 3GPP specification for reporting.

For the eTypeII based precoder, the UE may compress the precoder both in spatial domain (SD) and frequency domina (FD). In particular, the UE may derive the following information from codebookConfig in CSI-ReportConfig:
N₁: number of horizontal ports;
N₂: number of vertical ports;
P: number of polarizations;
S: number of Subbands for CQI reporting;
R: number of PMIs to be reported per CQI Subband;
PC: combination of:
   L: number of SD beams to be consider;
   pᵥ: the FD compression ratio; and
   β: the compression ratio to compute the number of coefficients to be reported.

According to the above information, the UE may calculate the following information:
N₃: number of PMIs to be reported over all subbands (N₃=S*R);
M: number of DFT vectors to be considered for FD compression. (M=┌pᵥ N₃/R┐);
O₁: the oversampling factor for horizontal domain;
O₂: the oversampling factor for vertical domain;
K₀: the maximum number of co-efficients to be reported per layer. (K₀=┌2βLM┐); and
v: The calculated rank or number of layers using the channel.

According to the above information, the computed precoders over all the subbands may be represented by using L+M×v DFT vectors and 2K₀ complex coefficients.

If Pₗ is the precoder for the layer l for all the subbands then it may be represented as:

$${P}_{l} = {W}_{1} * {W}_{2 , l} * {W}_{f , l}^{H} ,$$

where
W₁ represents the DFT based SD compression matrix which is common across all the layers.
W_{f,l} represents the DFT based FD compression matrix for layer l.
W_{2,l} represents the complex coefficient matrix for layer l.

The precoders may be compressed in SD using L orthogonal oversampled DFT basis vectors which may be represented by:

$${v}_{{m}_{1}^{( i )} , {m}_{2}^{( i )}} ,$$

where i=0, 1, . . . , L−1, v_{l,m} is represented as

$${u}_{m} = \{ \begin{matrix}[ 1 {e}^{j \frac{2 π m}{{N}_{2} {O}_{2}}} … {e}^{j \frac{2 π m ( {N}_{2} - 1 )}{{N}_{2} {O}_{2}}} ] & {N}_{2} > 1 \\ 1 & {N}_{2} = 1\end{matrix} \qquad ( 1.1 )$$

$${v}_{l , m} = {[ {u}_{m} {e}^{j \frac{2 π l}{{N}_{1} {O}_{1}}} {u}_{m} … {e}^{j \frac{2 π l ( {N}_{1} - 1 )}{{N}_{1} {O}_{1}}} {u}_{m} ]}^{T} . \qquad ( 1.2 )$$

The indices

$${m}_{1}^{( i )} , {m}_{2}^{( i )}$$

may represent the DFT basis vector indices in Horizontal and Vertical domain respectively and may be represented as:

$${m}_{1}^{( i )} = {n}_{1}^{( i )} {O}_{1} + {q}_{1} , \qquad ( 1.3 )$$

$$where {q}_{1} ∈ \{ 0 , 1 , … , {O}_{1} - 1 \} and {n}_{1}^{( i )} ∈ \{ 0 , 1 , … , {N}_{1} - 1 \} ; and$$

$${m}_{2}^{( i )} = {n}_{2}^{( i )} {O}_{2} + {q}_{2} , \qquad ( 1.4 )$$

$$where {q}_{2} ∈ \{ 0 , 1 , … , {O}_{2} - 1 \} and {n}_{2}^{( i )} ∈ \{ 0 , 1 , … , {N}_{2} - 1 \} .$$

The values of q₁, q₂ may be reported by using i_{1,1} as:

$${i}_{1.1} = [ {q}_{1} {q}_{2} ] . \qquad ( 1.5 )$$

The values of

$${n}_{1}^{( i )} , {n}_{2}^{( i )}$$

for i=0, 1, . . . , L−1 may be reported by using i_{1,2}∈

$$\{ 0 , 1 , … , ( \begin{matrix}{N}_{1} {N}_{2} \\ L\end{matrix} ) - 1 \}$$

using the following procedure:
let

$${n}^{( i )} = {n}_{2}^{( i )} {N}_{1} + {n}_{1}^{( i )} ,$$

where the indices i=0, 1, . . . , L−1 are assigned such that n⁽ⁱ⁾ increases, as i increases,

$$then {i}_{1 , 2} = {\sum }_{i = 0}^{L - 1} C ( {N}_{1} {N}_{2} - 1 - {n}^{( i )} , L - i ) , \qquad ( 1.6 )$$

$$where$$

$$C ( x , y ) = \{ \begin{matrix}( \begin{matrix}x \\ y\end{matrix} ) or {}^{x} {C}_{y} if x \geq y \\ 0 , otherwise\end{matrix} \} . \qquad ( 1.7 )$$

The precoders for each layer l may be compressed in FD using M DFT basis vectors which may be represented by:

$${y}_{l}^{( f )} where f = 0 , 1 , … , M - 1 , where {y}_{l}^{( f )} is represented as \qquad ( 1.8 )$$

$${y}_{l}^{( f )} = [ \begin{matrix}1 & {y}_{1 , l}^{( f )} & … & {y}_{M - 1 , l}^{( f )}\end{matrix} ] , {y}_{t , l}^{( f )} = {e}^{j \frac{2 π {tn}_{3 , l}^{( f )}}{{N}_{3}}} ,$$

$$where {n}_{3 , l}^{( f )}$$

represents the DFT vector indices for f=0, 1, . . . , M−1.

The M indices

$${n}_{3 , l}^{( f )} , f = 0 , 1 , … , M - 1$$

(f is assigned such that

$${n}_{3 , l}^{( f )}$$

increases as

$${n}_{3 , l}^{( 0 )} = 0 )$$

may be reported as

$${i}_{1 , 6 , l} ∈ \{ 0 , 1 , … , ( \begin{matrix}{N}_{3} - 1 \\ M - 1\end{matrix} ) - 1 \}$$

such that

$${i}_{1 , 6 , l} {\sum }_{f = 1}^{M - 1} ( \begin{matrix}{N}_{3} - 1 - {n}_{3 , l}^{( f )} \\ M - f\end{matrix} ) . \qquad ( 1.9 )$$

The DFT basis vectors formed by using the equations (1.2) and (1.8) form the SD and FD basis vectors respectively. The SD basis vector may be orthogonal since the value of oversampling offsets (q₁, q₂) for the selected DFT basis vectors is same. It should be noted that, based on the above codebook configuration and precoder reporting of current CSI framework, there is not any oversampling in FD, and all the selected DFT basis vectors in FD are orthogonal by default.

The total number of coefficients possible for each layer l may be 2 LM, and the UE may report a maximum of K₀ coefficients per layer and 2K₀ across all layers.

The total number of coefficients reported K_{NZ}≤2K₀ across all layers may be reported separately in CSI Part 1 (which is defined in 3GPP specification).

The UE may report a bitmap to represent the selected coefficient indices using i_{1,7,l}, where

$${K}_{l} = [ \begin{matrix}{k}_{l , 0 , 0}^{( 3 )} & … & {k}_{l , 0 , M - 1}^{( 3 )} \\ ⋮ & ⋱ & ⋮ \\ {k}_{l , 2 L - 1 , 0}^{( 3 )} & … & {k}_{l , 2 L - 1 , M - 1}^{( 3 )}\end{matrix} ] , \qquad ( 1.1 )$$

$$where {k}_{l , i , f}^{( 3 )} = 1$$

if corresponding coefficient is reported else 0.
Kₗ may be reported column-by-column in i_{1,7,l}.

The strongest coefficient index may be reported by using:
i_{1,8,l}∈{0, 1, . . . , 2L−1}.

The amplitude of the coefficients for layer l may be represented as:

$${P}_{l} = [ \begin{matrix}{p}_{l , 0}^{( 1 )} ( \begin{matrix}{p}_{l , 0 , 0}^{( 2 )} & … & {p}_{l , 0 , M - 1}^{( 2 )} \\ ⋮ & ⋱ & ⋮ \\ {p}_{l , L - 1 , 0}^{( 2 )} & … & {p}_{l , L - 1 , M - 1}^{( 2 )}\end{matrix} ) \\ {p}_{l , 1}^{( 1 )} ( \begin{matrix}{p}_{l , L , 0}^{( 2 )} & … & {p}_{l , L , M - 1}^{( 2 )} \\ ⋮ & ⋱ & ⋮ \\ {p}_{l , 2 L - 1 , 0}^{( 2 )} & … & {p}_{l , 2 L - 1 , M - 1}^{( 2 )}\end{matrix} )\end{matrix} ] , \qquad ( 1.11 )$$

$$where {p}_{l , i}^{( 1 )}$$

may be reported by using

$${k}_{l , p}^{( 1 )} ∈ \{ 0 , 1 , … , 15 \} and {p}_{l , i , f}^{( 2 )}$$

may be reported by using

$${k}_{l , i , f}^{( 2 )} ∈ \{ 0 , 1 , … , 7 \} .$$

The amplitude coefficients

$${k}_{l , p}^{( 1 )} , p = 0 , 1$$

may be reported by using

$${i}_{2 , 3 , l} = [ {k}_{l , 0}^{( 1 )} {k}_{l , 1}^{( 1 )} ] .$$

The amplitude coefficients

$${k}_{l , i , f}^{( 2 )}$$

corresponding to

$${P}_{l , i , f}^{( 2 )}$$

of the Pₗ matrix may be reported in i_{2,4,l} in column-by-column fashion.

The phase of the coefficients for layer l may be represented as:

$${φ}_{l} = [ \begin{matrix}{φ}_{l , 0 , 0} & … & {φ}_{l , 0 , M - 1} \\ ⋮ & ⋱ & ⋮ \\ {φ}_{l , 2 L - 1 , 0} & … & {φ}_{l , 2 L - 1 , M - 1}\end{matrix} ] , \qquad ( 1.12 )$$

$$where {φ}_{l , i , f} = {e}^{j \frac{2 π {c}_{l , i , f}}{16}} , {c}_{l , i , f} ∈ \{ 0 , 1 , … , 15 \} .$$

The phase coefficients c_{l,i,f} corresponding to φ_{l,i,f} of the φₗ matrix may be reported in i_{2,5,l} in column-by-column fashion.

The UE may report i_{1,1}, i_{1,2}, i_{1,3}, i_{1,6}, i_{1,7}, i_{1,8}, i_{2,3}, i_{2,4}, i_{2,5} in the following order:

$${i}_{1} = \{ \begin{matrix}[ {i}_{1 , 1} {i}_{1 , 2} {i}_{1 , 6 , 1} {i}_{1 , 7 , 1} {i}_{1 , 8 , 1} ] & v = 1 \\ [ {i}_{1 , 1} {i}_{1 , 2} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} ] & v = 2 \\ [ {i}_{1 , 1} {i}_{1 , 2} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} ] & v = 3 \\ [ {i}_{1 , 1} {i}_{1 , 2} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} {i}_{1 , 6 , 4} {i}_{1 , 7 , 4} {i}_{1 , 8 , 4} ] & v = 4\end{matrix}$$

$${i}_{2} = \{ \begin{matrix}[ {i}_{2 , 3 , 1} {i}_{2 , 4 , 1} {i}_{2 , 5 , 1} ] & v = 1 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} ] & v = 2 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} {i}_{2 , 3 , 3} {i}_{2 , 4 , 3} {i}_{2 , 5 , 3} ] & v = 3 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} {i}_{2 , 3 , 3} {i}_{2 , 4 , 3} {i}_{2 , 5 , 3} {i}_{2 , 3 , 4} {i}_{2 , 4 , 4} {i}_{2 , 5 , 4} ] & v = 4\end{matrix}$$

Regarding precoder reconstruction of 3GPP eTypeII precoder under current CSI framework, after receiving the i₁, i₂, the network node may perform the following steps:
Step 1: extract q₁ and q₂ from i_{1,1};
Step 2:

$${n}_{1}^{( i )} and {n}_{2}^{( i )}$$

from i_{1,2} is found using the algorithm:
s₋₁=0
for i=0, 1, . . . , L−1
find the largest x*∈{L−1−i, . . . , N₁N₂−1−i} such that i_{1,2}−sᵢ₋₁≥C(x*, L−i) where C(x, y) is represented in the equation (1.7)

$${e}_{i} = C ( {x}^{*} , L - i )$$

$${s}_{i} = {s}_{i - 1} + {e}_{i}$$

$${n}^{( i )} = {N}_{1} {N}_{2} - 1 - {x}^{*}$$

$${n}_{1}^{( i )} = {n}^{( i )} mod {N}_{1}$$

$${n}_{1}^{( i )} = \frac{( {n}^{( i )} - {n}_{1}^{( i )} )}{{N}_{1}} ;$$

Step 3: find

$${m}_{1}^{( \dot{i} )} = {n}_{1}^{( i )} {O}_{1} + {q}_{1} and {m}_{2}^{( i )} = {n}_{2}^{( i )} {O}_{2} + {q}_{2}$$

for i=0, 1, . . . , L−1;
Step 4: for each layer l,
   Step 4_1:

$${n}_{3 , l}^{( f )} ,$$

f=0, 1, . . . , M−1 from i_{1,6,l} is found using the algorithm:

$${s}_{- 1} = 0$$

for f=0, 1, . . . , M−1
find the largest x*∈{M−1−f, . . . , N₃−1−f} such that i_{1,6,l}−s_{f-1}≥C(x*,M−f) where C(x, y) is represented in the equation (1.7)

$${e}_{f} = C ( {x}^{*} , M - f )$$

$${s}_{f} = {s}_{f - 1} + {e}_{f}$$

$${n}_{3 , l}^{( f )} = {N}_{3} - 1 - {x}^{*} ;$$

Step 4_2: extract Kₗ matrix by re-arranging the i_{1,7,l} bit map into a matrix of 2 L×M size;
Step 4_3: compute

$${N}_{l}^{NZ} = {\sum }_{f = 0}^{M - 1} {\sum }_{i = 0}^{2 L - 1} {k}_{l , i , f}^{( 3 )} ;$$

Step 4_4: extract

$${k}_{l , 0}^{( 1 )} , {k}_{l , 1}^{( 1 )}$$

from i_{2,3,l} and find the corresponding

$${p}_{l , 0}^{( 1 )} , {p}_{l , 1}^{( 1 )} ;$$

Step 4_5: extract

$${k}_{l , i , f}^{( 2 )} for {K}_{l}^{NZ}$$

reported coefficients

$$( for which {k}_{l , i , f}^{( 3 )} = 1 )$$

and find the corresponding

$${p}_{l , i , f}^{( 2 )} ;$$

Step 4_6: extract c_{l,i,f} for

$${K}_{l}^{NZ}$$

reported coefficients

$$( for which {k}_{l , i , f}^{( 3 )} = 1 )$$

and find the corresponding φ_{l,i,f}; and
Step 5: compute the precoder for each layer according to 3GPP specification.

Regarding PMI bit width computation for uplink control information (UCI) of 3GPP eTypeII precoder under current CSI framework, the bit width for PMI of eTypeII codebook may be determined based on the following table:

| | Parameter | Bit Width |
|---|---|---|
| | i_{1,1} | ┌log₂(O₁O₂)┐ |
| | i_{1,2} | $⌈ {log}_{2} ( \begin{matrix}{N}_{1} {N}_{2} \\ L\end{matrix} ) ⌉$ |
| These are reported per layer | i_{1,6,l} | $⌈ {log}_{2} ( \begin{matrix}{N}_{3} - 1 \\ M - 1\end{matrix} ) ⌉$ |
| | i_{1,7,l} | 2LM |
| | i_{1,8,l} | ┌log₂(2L)┐ |
| | ${K}_{l}^{NZ}$ | ┌log₂(┌2βLM┐)┐ |
| | i_{2,3,l} | 4 |
| | i_{2,4,l} | $3 ( {K}_{l}^{NZ} - 1 )$ |
| | i_{2,5,l} | $4 ( {K}_{l}^{NZ} - 1 )$ |

Regarding codebook configuration and precoder reporting of 3GPP eTypeII precoder for C-JT (i.e., codebook configuration and precoder reporting of 3GPP Release-18 eTypeII Precoder for C-JT) under current CSI framework, the UE may compress the C-JT precoder both in SD and FD. The UE may derive the following information from codebookConfig of CSI-ReportConfig in the RRC configuration:
N_{TRP}: vumber of CSI-RS resources for C-JT;
PC: combination of:
   {L₁_L_{NTRP}}: number of SD beams to be considered per TRP;
   pᵥ: the Frequency domain (FD) compression ratio; and
   β: the compression ratio to compute the number of coefficients to be reported.

According to the above information, the UE may calculate the following information: K₀: the maximum number of co-efficients to be reported per layer.

$$( {K}_{0} = ⌈ 2 β M {\sum }_{j = 1}^{N} {L}_{{σ}_{j}} ⌉ ) ,$$

where {σ₁, . . . , σ_{N}} are the indices of N selected CSI-RS resources out of N_{TRP}, and
{L_{σ}_{₁}, . . . , L_{σ}_{_{N}}} are the corresponding values from the selected combination of {L₁ . . . L_{NTRP}};
   v: the calculated rank or number of layers using the channel; and
   other parameters configured as in the above section.

According to the above parameters, the computed precoders over all the subbands may be represented by using

$${\sum }_{j = 1}^{N} {L}_{{σ}_{j}} + M \times v DFT$$

vectors and 2K₀ complex coefficients.

If Pₗ is the precoder for the layer l for all the subbands then it may be represented as:

$${P}_{l} = {W}_{1} * {W}_{2 , l} * {W}_{f , l}^{H} ,$$

where
W₁ represents the DFT based SD compression matrix which is common across all the layers.

W₁ may be represented as:

$${W}_{1} = [ \begin{matrix}{W}_{1 , 1} & 0 & 0 \\ 0 & ⋱ & 0 \\ 0 & 0 & {W}_{1 , N}\end{matrix} ] ,$$

where W_{1,k} represents the SD compression matrix for k^{th} resource.
   W_{f,l} represents the DFT based FD compression matrix for layer l. W_{2,l} represents the complex coefficient matrix for layer l.

The precoder of j^{th} selected resource may be compressed in SD by using L_{σ}_{ⱼ} orthogonal oversampled DFT vectors which may be represented by:

$${v}_{{m}_{1 , j}^{( i )} , {m}_{2 , j}^{( i )}}$$

where i=0, 1, . . . , L_{σ}_{ⱼ}−1, v_{l,m} is represented as

$${u}_{m} = \{ \begin{matrix}[ \begin{matrix}1 & {e}^{j \frac{2 π m}{{N}_{2} {O}_{2}}} & ... & {e}^{j \frac{2 π m ( {N}_{2} - 1 )}{{N}_{2} {O}_{2}}}\end{matrix} ] & {N}_{2} > 1 \\ 1 & {N}_{2} = 1\end{matrix} \qquad ( 1 )$$

$${v}_{l , m} = {[ \begin{matrix}{u}_{m} & {e}^{j \frac{2 π l}{{N}_{1} {O}_{1}}} {u}_{m} & ... & {e}^{j \frac{2 π l ( {N}_{1} - 1 )}{{N}_{1} {O}_{1}}} {u}_{m}\end{matrix} ]}^{T} \qquad ( 2 )$$

The indices

$${m}_{1 , j}^{( i )} , {m}_{2 , j}^{( i )}$$

may represent the DFT vector indices in Horizontal and Vertical domain respectively and may be represented as:

$${m}_{1 , j}^{( i )} = {n}_{1 , j}^{( i )} {O}_{1} + {q}_{1 , j} , \qquad ( 3 )$$

$$where {q}_{1 , j} ∈ \{ 0 , 1 , ... , {O}_{1} - 1 \} and {n}_{1 , j}^{( i )} ∈ \{ 0 , 1 , ... , {N}_{1} - 1 \} , and$$

$${m}_{2 , j}^{( i )} = {n}_{2 , j}^{( i )} {O}_{2} + {q}_{2 , j} , \qquad ( 4 )$$

$$where {q}_{2 , j} ∈ \{ 0 , 1 , ... , {O}_{2} - 1 \} and {n}_{2 , j}^{( i )} ∈ \{ 0 , 1 , ... , {N}_{2} - 1 \} .$$

The values of q_{1,j}, q_{2,j} may be reported by using i_{1,1} as:

$${i}_{1 , 1 , j} = [ \begin{matrix}{q}_{1 , j} & {q}_{2 , j}\end{matrix} ] and {i}_{1 , 1} = [ \begin{matrix}{i}_{1 , 1 , 1} & ... & {i}_{1 , 1 , N}\end{matrix} ] . \qquad ( 5 )$$

The values of

$${n}_{1 , j}^{( i )} , {n}_{2 , j}^{( i )}$$

for i=0, 1, . . . , L−1 may be reported by using i_{1,2,j}∈

$$\{ 0 , 1 , ... , ( \begin{matrix}{N}_{1} {N}_{2} \\ L\end{matrix} ) - 1 \}$$

using the following procedure:
let

$${n}_{j}^{( i )} = {n}_{2 , j}^{( i )} {N}_{1} + {n}_{1 , j}^{( i )} ,$$

where the indices i=0, 1, . . . , L_{σ}_{ⱼ}−1 are assigned such that

$${n}_{j}^{( i )}$$

increases,

$$then {i}_{1 , 2 , j} = {\sum }_{i = 0}^{{L}_{{σ}_{j}} - 1} C ( {N}_{1} {N}_{2} - 1 - {n}_{j}^{( i )} , {L}_{{σ}_{j}} - i ) , \qquad ( 6 )$$

$$where$$

$$C ( x , y ) = \{ \begin{matrix}( \begin{matrix}x \\ y\end{matrix} ) or {}^{x} {C}_{y} if x \geq y \\ 0 , otherwise\end{matrix} \} \qquad ( 7 )$$

$$and {i}_{1 , 2} = [ {i}_{1 , 2 , 1} … {i}_{1 , 2 , N} ] .$$

The other indices may be reported as specified in 3GPP specification.

Regarding precoder reconstruction of 3GPP eTypeII precoder for C-JT under current CSI framework, after receiving the i₁, i₂, the network node may perform the following steps:
Step 1: extract q_{1,j} and q_{2,j} from i_{1,1,j};
Step 2:

$${n}_{1 , j}^{( i )} and {n}_{2 , j}^{( i )}$$

from i_{1,2,j} is found using the algorithm:

$${s}_{- 1} = 0$$

for i=0, 1, . . . , L_{σ}_{ⱼ}−1
find the largest x*∈{L_{σ}_{ⱼ}−1−i, . . . , N₁N₂−1−i} such that i_{1,2}−sᵢ₋₁≥C(x*,L_{σ}_{ⱼ}−i)
where C(x, y) is represented in the equation (7)

$${e}_{i} = C ( {x}^{*} , {L}_{{σ}_{j}} - i )$$

$${s}_{i} = {s}_{i - 1} + {e}_{i}$$

$${n}_{j}^{( i )} = {N}_{1} {N}_{2} - 1 - {x}^{*}$$

$${n}_{1 , j}^{( i )} = {n}_{j}^{( i )} mod {N}_{1}$$

$${n}_{2 , j}^{( i )} = \frac{( {n}_{j}^{( i )} - {n}_{1 , j}^{( i )} )}{{N}_{1}} ;$$

Step 3: find

$${m}_{1 , j}^{( i )} = {n}_{1 , j}^{( i )} {O}_{1} + {q}_{1 , j} and {m}_{2 , j}^{( i )} = {n}_{2 , j}^{( i )} {O}_{2} + {q}_{2 , j}$$

for i=0, 1, . . . , L_{σ}_{ⱼ}−1; and
Step 4: for each layer l, and resource σⱼ, the other coefficients may be computed and precoder may be reconstructed according to 3GPP specification.

Regarding PMI bit width computation for UCI of 3GPP eTypeII precoder for C-JT under current CSI framework, the bit width for PMI of eTypeII codebook may be determined based on the following table:

| Parameter | Bit Width |
|---|---|
| i_{1,1} | N┌log₂(O₁O₂)┐ |
| i_{1,2} | ${\sum }_{j = 1}^{N} ⌈ {log}_{2} ( \begin{matrix}{N}_{1} {N}_{2} \\ {L}_{{σ}_{j}}\end{matrix} ) ⌉$ |
| i_{1,6,l} | $⌈ {log}_{2} ( \begin{matrix}{N}_{3} - 1 \\ M - 1\end{matrix} ) ⌉$ |
| i_{1,7,l} | $2 M {\sum }_{j = 1}^{N} {L}_{{σ}_{j}}$ |
| i_{1,8,l} | $⌈ {log}_{2} ( 2 {\sum }_{j = 1}^{N} {L}_{{σ}_{j}} ) ⌉$ |
| ${K}_{l}^{NZ}$ | $⌈ {log}_{2} ( ⌈ 2 β M {\sum }_{j = 1}^{N} {L}_{{σ}_{j}} ⌉ ) ⌉$ |
| i_{2,3,l} | 4 |
| i_{2,4,l} | $3 ( {K}_{l}^{NZ} - 1 )$ |
| i_{2,5,l} | $4 ( {K}_{l}^{NZ} - 1 )$ |

Regarding codebook configuration and precoder reporting of 3GPP eTypeII precoder for predicted PMI (i.e., codebook configuration and precoder reporting of 3GPP Release-18 eTypeII Precoder for predicted PMI) under current CSI framework, the UE may be configured with the value of N₄ such that the PMI indicates N₃ precoder matrices for each of the N₄ consecutive slot intervals.

The other parameters may be configured as the parameters used in codebook configuration and precoder reporting of 3GPP eTypeII precoder (i.e., codebook configuration and precoder reporting of 3GPP Release-16 eTypeII Precoder).

If N₄=1, the PMI may be reported similar to the PMI reporting procedure of 3GPP eTypeII precoder (i.e., 3GPP Release-16 eTypeII Precoder).

If N₄>1, the PMI may be indicated by using L+M+Q DFT vectors. The Q=2 vectors,

$${[ {z}_{0 , l}^{( τ )} , {z}_{1 , l}^{( τ )} , … , {z}_{{N}_{4} - 1 , l}^{( τ )} ]}^{T} ,$$

τ=0, 1, for layer l=1, . . . , v may be identified by n_{4,l}, where

$${n}_{4 , l} = [ \begin{matrix}{n}_{4 , l}^{( 0 )} & {n}_{4 , l}^{( 1 )}\end{matrix} ]$$

$${n}_{4 , l}^{( τ )} ∈ \{ 0 , 1 , … , {N}_{4} - 1 \}$$

with the indices τ∈{0,1} assigned such that

$${n}_{4 , l}^{( τ )}$$

may increase with τ. n_{4,l} may be indicated by the index i_{1,10,l}, for layer l=1, . . . , v, where

$${i}_{1 , 10 , l} ∈ \{ 0 , 1 , … , {N}_{4} - 2 \} .$$

If N₄=2, i_{1,10,l}, for layer l=1, . . . , v may not be reported.

If N₄∈{4,8}, the nonzero offset between

$${n}_{4 , l}^{( 0 )} and {n}_{4 , l}^{( 1 )}$$

may be reported with i_{1,10,l} assuming that

$${n}_{4 , l}^{( 0 )}$$

(reference for the offset) is 0. The nonzero offset values may be mapped to the index values of i_{1,10,l} in increasing order with offset value 1 mapped to index value ‘0’.

The Q=2 vectors' elements may be given by:

$${z}_{ι , l}^{( τ )} = {e}^{j \frac{2 π \cdot ι \cdot {n}_{4 , l}^{( τ )}}{{N}_{4}}}$$

for i=0, 1, . . . . N₄−1, and τ=0,1.
Let

$${K}_{l}^{NZ} = {\sum }_{τ = 0}^{Q - 1} {\sum }_{i = 0}^{2 L - 1} {\sum }_{f = 0}^{{M}_{v} - 1} {k}_{l , i , f , τ}^{( 3 )} \leq {K}_{0}$$

be the number of nonzero coefficients for layer l=1, . . . , v, the total number of nonzero coefficients may be reported and given by

$${K}^{NZ} = {\sum }_{l = 1}^{v} {K}_{l}^{NZ} \leq 2 {K}_{0} .$$

The indices i_{1,1}, i_{1,2}, i_{1,3}, i_{1,6}, i_{1,7}, i_{1,8}, i_{2,3}, i_{2,4}, i_{2,5} may be computed and reported as in 3GPP specification.

Regarding PMI bit width computation for UCI of 3GPP eTypeII precoder for predicted PMI under current CSI framework, the bit width for PMI of eTypeII codebook may be determined based on the following table:

| | Parameter | Bit Width |
|---|---|---|
| | i_{1,1} | ┌log₂(O₁O₂)┐ |
| | i_{1,2} | $⌈ {log}_{2} ( \begin{matrix}{N}_{1} {N}_{2} \\ L\end{matrix} ) ⌉$ |
| These are reported per layer | i_{1,6,l} | $⌈ {log}_{2} ( \begin{matrix}{N}_{3} - 1 \\ M - 1\end{matrix} ) ⌉$ |
| | i_{1,7,l} | 2LMQ |
| | i_{1,8,l} | ┌log₂(2LQ)┐ |
| | i_{1,10,l} | log₂(N₄ − 1) |
| | ${K}_{l}^{NZ}$ | ┌log₂(┌2βLMQ┐)┐ |
| | i_{2,3,l} | 4 |
| | i_{2,4,l} | $3 ( {K}_{l}^{NZ} - 1 )$ |
| | i_{2,5,l} | $4 ( {K}_{l}^{NZ} - 1 )$ |

Based on eTypeII codebook, oversampling in SD may be introduced to capture more granular information. However, it may also restrict the codebook to utilize only orthogonal DFT vectors to determine precoder so that the inter-layer interference may be reduced. This restriction may limit the performance since a higher granular information may be completely used.

Regarding to the present disclosure, non-orthogonal DFT (considering all oversampled DFT vectors instead of the ones with same offset) basis vectors are introduced for precoder formation and reporting. In addition, some implementations of reporting SD and FD basis vectors considering the overhead and other configurations are introduced. In particular, regarding to the present disclosure, a network node may transmit a configuration to a UE to configure the UE to determine a CSI report including information of a plurality of non-orthogonal basis vectors with a plurality of oversampling factors. The UE may transmit the CSI report to the network node. The network node may determine a precoder for data transmission according to the information of the plurality of non-orthogonal basis vectors with the plurality of oversampling factors Therefore, because the precoder may be determined based on the plurality of non-orthogonal basis vectors, the compression error caused by using orthogonal basis vectors can be significant reduced.

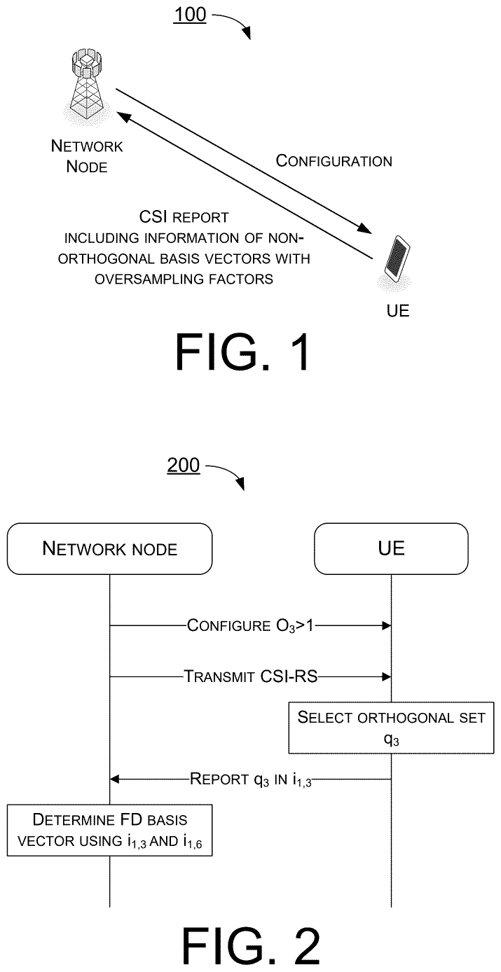

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network node may transmit a configuration to the UE. The configuration may be used to configure the UE to determine a CSI report including information of a plurality of non-orthogonal basis vectors with a plurality of oversampling factors. More specifically, after receiving a CSI-RS from the network node, the UE may determine the CSI report which includes additional information of the plurality of non-orthogonal basis vectors with the plurality of oversampling factors. Then, the UE may transmit the CSI report to the network node. After receiving the CSI report, the network node may determine a precoder for data transmission (e.g., the precoder for later DL transmission) according to the information of the plurality of non-orthogonal basis vectors with the plurality of oversampling factors.

In some embodiments, the UE may determine the CSI report including the information of the plurality of non-orthogonal basis vectors with the plurality of oversampling factors in SD and/or FD and/or time domain (TD). In other words, the non-orthogonal basis vectors may include a combination of one or more SD basis vectors, one or more FD basis vectors and one or more TD basis vectors. In other words, the non-orthogonal basis vectors may include SD basis vector(s) and/or FD basis vector(s) and/or TD basis vector(s).

In some embodiments, the configuration may be included in an RRC configuration (i.e., the configuration may be transmitted via the RRC configuration,) and may include: (1) a plurality of first parameters for the UE to determine the CSI report including the information of the plurality of non-orthogonal basis vectors; and/or (2) a plurality of second parameters for the UE to determine a frequency oversampling offset and a time oversampling offset of the plurality of oversampling factors; and/or (3) a plurality of third parameters for the UE to determine a composite SD and FD basis vector and to determine a value of number of basis vectors selected for composite; and/or (4) a plurality of fourth parameters for the UE to determine a common FD basis vector and a common TD basis vector for all layers.

For example, the plurality of first parameters is additionally included in CodebookConfig (which is information element in 3rd Generation Partnership Project (3GPP) specification) of the RRC configuration. The plurality of first parameters includes: (1) a non-orthogonal SD basis vector parameter (e.g., parameter named enableNonOrthogonalSDBasis); and/or (2) a non-orthogonal FD basis vector parameter (e.g., parameter named enableNonOrthogonalFDBasis); and/or (3) a non-orthogonal TD basis vector parameter (e.g., parameter named enableNonOrthogonalTDBasis). The plurality of first parameter is set to “true” for enabling the UE to determine the CSI report including the information of the non-orthogonal basis vectors.

For example, the plurality of second parameters is additionally included in CodebookConfig of the RRC configuration. The plurality of second parameters includes: (1) frequency oversampling parameter (e.g., parameter named frequencyOversampling); and/or (2) a time oversampling parameter (e.g., parameter named timeOversampling); and/or (3) a value of the frequency oversampling parameter (e.g., parameter named valueOfO3); and/or (4) a value of the time oversampling parameter (e.g., parameter named valueOfO4).

For example, the plurality of third parameters is additionally included in CodebookConfig of the RRC configuration. The plurality of third parameters includes: (1) a composite SD and vector FD basis parameter (e.g., parameter named enableCompositeSDFDBasis); and/or (2) a value of number of basis vectors selected for composite (e.g., parameter named vlaueOfK). The composite SD and FD basis vector parameter is set to “true” for enabling the UE to determine a composite SD and FD basis vector.

For example, the plurality of fourth parameters is additionally included in CodebookConfig of the RRC configuration. The plurality of fourth parameters includes: (1) a common frequency domain basis vector parameter (e.g., parameter named enableCommonFDBasis); and/or (2) a common time domain basis vector parameter (e.g., parameter named enableCommonTDBasis); and/or a common frequency domain offset parameter (e.g., parameter named enableCommonFDOffset). The plurality of fourth parameter is set to “true” for enabling the UE to determine the common FD basis vector and the common TD basis vector for all layers.

In some embodiments, the configuration may include the plurality of second parameters. The plurality of second parameters may include the frequency oversampling parameter (e.g., frequencyOversampling), the time oversampling parameter (e.g., timeOversampling), the value of the frequency oversampling factor (e.g., valueOfO3) and the value of the time oversampling factor (e.g., valueOfO4). The frequency oversampling offset may be determined by the UE according to the frequency oversampling parameter and the value of the frequency oversampling factor. The time oversampling offset may be determined by the UE according to the time oversampling parameter and the value of the time oversampling factor. The network node may receive the frequency oversampling offset and the time oversampling offset from the UE. The network node may determine a frequency domain basis vector and/or a time domain basis vector according to the frequency oversampling offset and the time oversampling offset.

More specifically, because eTypeII codebook may support oversampling for SD basis vector and introducing oversampling may increase the granularity of the information, oversampling for FD and TD basis vector may be introduced.

In some implementations, the plurality of second parameters may be used in CodebookConfig in the RRC configuration for introducing oversampling for frequency and time domain basis vectors. For example, frequencyOversampling and timeOversampling of the plurality of second parameters may be set to “true” for enabling the oversampling for FD and TD basis vectors. valueOfO3 and valueOfO4 of the plurality of second parameters may be set for determining oversampling offsets.

In particular, the UE may need to report an oversampling offset q₃ (i.e., the frequency oversampling offset) used for selecting M DFT basis vectors for FD compression. Moreover, this value of q₃ may be selected separately for each layer or same across all layers based on enableCommonFDOffset of the plurality of the fourth parameter in RRC configuration.

In some implementations, if enableCommonFDOffset is set to “true”, then M FD based DFT basis vector may be constructed using the following equation instead of equation (1.8):

$${y}_{l}^{( f )} ,$$

where f=0, 1, . . . , M−1, where

$${y}_{l}^{( f )}$$

is represented as

$${y}_{l}^{( f )} = [ \begin{matrix}1 & {y}_{1 , l}^{( f )} & ... & {y}_{M - 1 , l}^{( f )}\end{matrix} ] , {y}_{t , l}^{( f )} = {e}^{j \frac{2 π {tm}_{3 , l}^{( f )}}{{N}_{3} {O}_{3}}} , \qquad ( 2.8 \text{.1} )$$

$$where {m}_{3 , l}^{( f )} = {n}_{3 , l}^{( f )} {O}_{3} + {q}_{3} ,$$

$${q}_{3} ∈ \{ 0 , 1 , ... , {O}_{3} - 1 \} ,$$

$$where {n}_{3 , l}^{( f )}$$

represents the DFT vector indices for f=0, 1, . . . , M−1.

The value of q₃, which selects a particular set of orthogonal FD basis vector among all FD basis vector, may be reported in i_{1,3} as i_{1,3}=[q₃]. The values of

$${n}_{3 , l}^{( f )}$$

may be reported as same procedure in equation (1.9) using i_{1,6,l}. The bit width for i_{1,3} is ┌log₂(O₃)┐ and i_{1,6,l} is

$$⌈ {log}_{2} ( \begin{matrix}{N}_{3} \\ M\end{matrix} ) ⌉ .$$

In some implementations, if enableCommonFDOffset is set to “false”, then the FD based DFT basis vector may be constructed using the following equation instead of equation (1.8):

$${y}_{l}^{( f )} ,$$

where f=0, 1, . . . , M−1, where

$${y}_{l}^{( f )}$$

is represented as

$${y}_{l}^{( f )} = [ \begin{matrix}1 & {y}_{1 , l}^{( f )} & ... & {y}_{M - 1 , l}^{( f )}\end{matrix} ] , {y}_{t , l}^{( f )} = {e}^{j \frac{2 π {tm}_{3 , l}^{( f )}}{{N}_{3} {O}_{3}}} , \qquad ( 2.8 \text{.2} )$$

$$where {m}_{3 , l}^{( f )} = {n}_{3 , l}^{( f )} {O}_{3} + {q}_{3 , l} and$$

$${q}_{3 , l} ∈ \{ 0 , 1 , ... , {O}_{3} - 1 \} .$$

The value of q_{3,l} may be reported in i_{1,3} as i_{1,3,l}=[q_{3,l}]. The values of

$${n}_{3 , l}^{( f )}$$

may be reported as above procedure in eTypeII using i_{1,6,l}. The bit width for i_{1,3,l} may be ┌log₂(O₃)┐ and i_{1,6,l} may i_{1,6,l} may be

$$⌈ {log}_{2} ( \begin{matrix}{N}_{3} \\ M\end{matrix} ) ⌉ .$$

Regarding the above eTypeII precoder reporting with oversampling FD basis vector, FIG. 2 illustrates an example scenario 200 under schemes in accordance with implementations of the present disclosure. The network node may configure O₃>1. The UE may receive the CSI-RS and determine a precoder. The UE may select orthogonal set q₃ and report the orthogonal set q₃ in i_{1,3}. The network node may determine the FD basis vector using i_{1,3} and i_{1,6}.

In some implementations, the UE may need to report an oversampling offset q₄ (i.e., the time oversampling offset) used for selecting Q=2 DFT basis vectors for TD compression. Moreover, this value of q₄ may be selected separately for each layer or same across all layers based on enableCommonTDOffset of the plurality of the fourth parameter in RRC configuration.

In particular, the TD based DFT basis vectors may be constructed by using the following equation:

$${z}_{ι , l}^{( τ )} = {e}^{j \frac{2 π \cdot ι \cdot {m}_{4 , l}^{( τ )}}{{N}_{4} {O}_{4}}} ,$$

$$where {m}_{4 , l}^{( τ )} = {n}_{4 , l}^{( τ )} {O}_{4} + {q}_{4 , l} , for ι = 0 , 1 , ... {N}_{4} - 1 , and$$

$$τ = 0 , 1 \cdot \& {n}_{4 , l}^{( τ )} ∈ \{ 0 , 1 , ... , {N}_{4} - 1 \} \& {q}_{4 , l} ∈ \{ 0 , 1 , ... , {O}_{4} - 1 \} .$$

The value of q_{4,l} my be reported in i_{1,4,l}=[q_{4,l}] and

$${n}_{4 , l}^{( τ )}$$

in i_{1,10,l} as described in previous sections of 3GPP eTypeII precoder for predicted PMI.

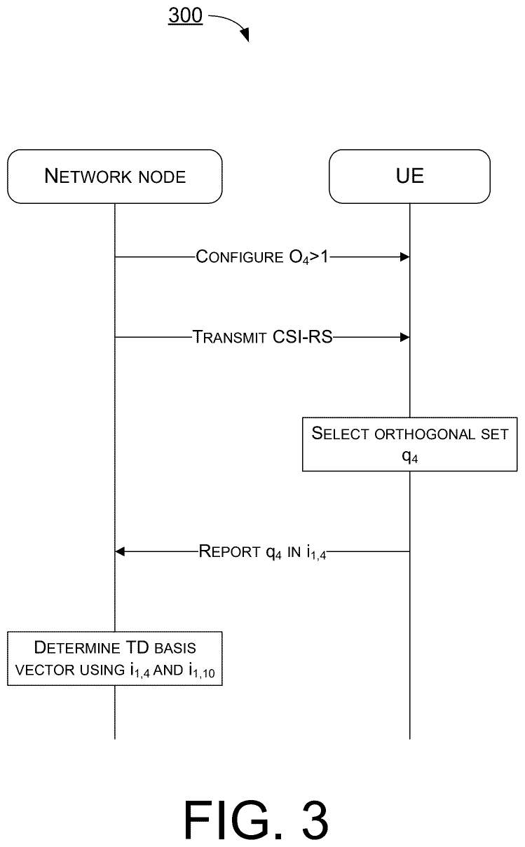

Regarding the above eTypeII precoder reporting with oversampling TD basis vector, FIG. 3 illustrates an example scenario 300 under schemes in accordance with implementations of the present disclosure. The network node may configure O₄>1. The UE may receive the CSI-RS and determine a precoder. The UE may select orthogonal set q₄ and report the orthogonal set q₄ in i_{1,4}. The network node may determine the TD basis vector using i_{1,4} and i_{1,10}.

In some implementations, the values of O₁ and O₂ may be fixed for the values of N₁ and N₂, which may reduce the flexibility to increase or reduce the granularity and may also fix the overhead for basis selection. In some cases, the values of O₁, O₂, O₃, O₄ may be configured by using the parameters valueOfO1, valueOfO2, valueOfO3, valueOfO4 in CodebookConfig in the RRC Configuration. In some cases, the oversampling values O₁, O₂, O₃ and O₄ above may be selected or determined by the UE and reported to the network node in Part 1 of the CSI Report (which is defined in 3GPP specification).

In some embodiments, the configuration may include the plurality of fourth parameters. The plurality of fourth parameters may include the common frequency domain basis vector parameter (e.g., enableCommonFDBasis) and the common time domain basis vector parameter (e.g., enableCommonTDBasis). The UE may determine a plurality of first DFT vectors according to common frequency domain basis vector parameter and/or determine a plurality of second DFT vectors according to common time domain basis vector parameter. The network node may receive the plurality of first DFT vectors and the plurality of second DFT vectors from the UE and determine a frequency domain basis vector and a time domain basis vector according to the plurality of first DFT vectors and the plurality of second DFT vectors.

More specifically, because time and frequency correlation across antennas may be similar and reporting per-layer TD and FD basis vectors may increase the overhead, a common TD and FD basis vector may be introduced for all the layers for the eTypeII Codebook. In particular, the plurality of fourth parameters may be used to enable the function of common TD and FD basis vector by setting parameters enableCommonFDBasis and enableCommonTDBasis of the plurality of fourth parameters in CodebookConfig in the RRC configuration to “true”.

In some cases regarding FD the DFT basis indices

$${n}_{3 , l}^{( f )}$$

may be the same across the layers and may be modified as

$${n}_{3}^{( f )} ,$$

and i_{1,6,l} may be replaced with i_{1,6}. The bit width for i_{1,6} may be

$$⌈ {log}_{2} ( \begin{matrix}{N}_{3} \\ M\end{matrix} ) ⌉$$

and may be reported only once for all the layers. In some cases, if O₃>1, then enableCommonFDOffset may be set to “false” and q₃ may be reported as above q₃ reporting procedures.

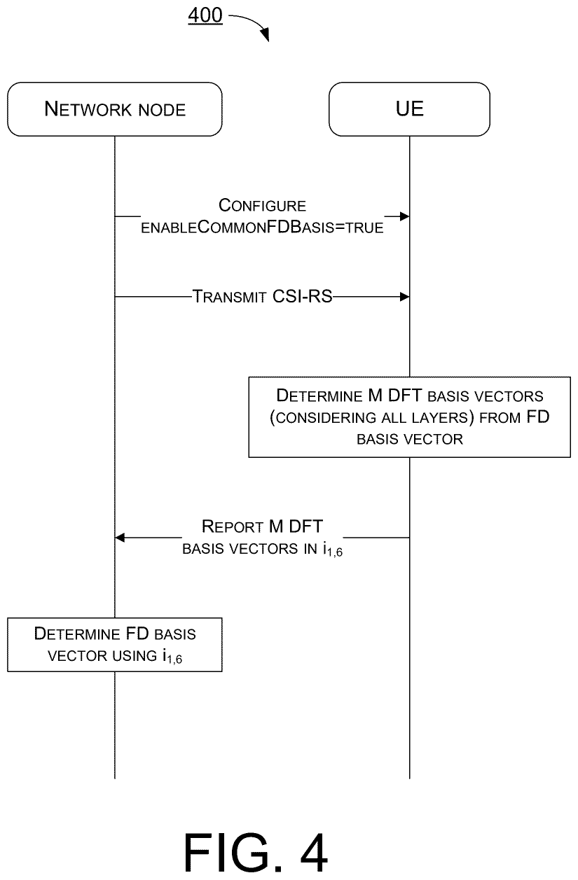

Regarding the above eTypeII precoder reporting with the common FD basis vector, FIG. 4 illustrates an example scenario 400 under schemes in accordance with implementations of the present disclosure. The UE may receive the CSI-RS and determine a precoder. The UE may determine M DFT basis vectors considering all layers from FD basis vector and report the M DFT basis vectors in i_{1,6}. The network node may determine the FD basis vector using i_{1,6}.

In some cases regarding TD, the DFT basis indices

$${n}_{4 , l}^{( τ )}$$

may be the same across the layers and may be modified as

$${n}_{4}^{( τ )} ,$$

and i_{1,10,l} may be replaced with i_{1,10}. In some cases, if O₄>1, then enableCommonTDOffset may be set to “false” and q₄ is reported as above q₄ reporting procedures.

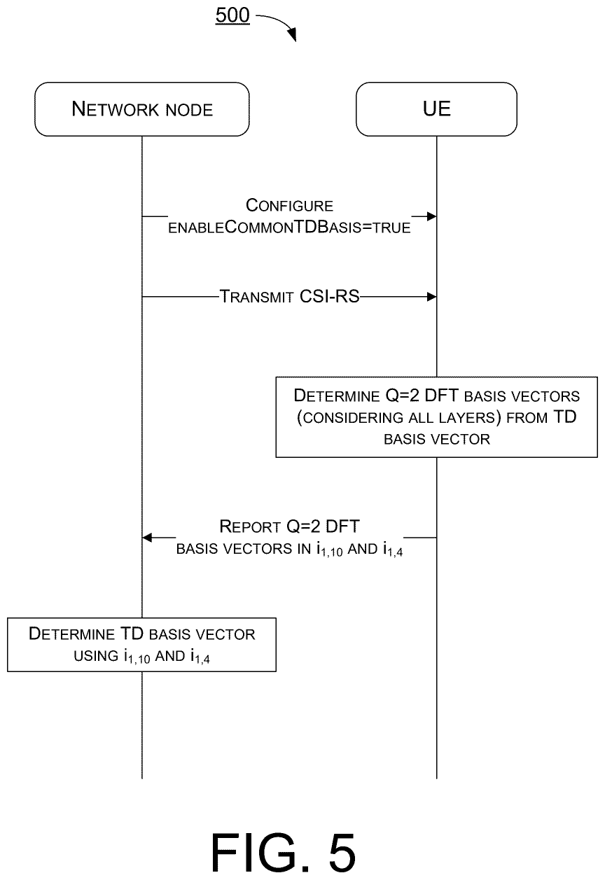

Regarding the above eTypeII precoder reporting with the common TD basis vector, FIG. 5 illustrates an example scenario 500 under schemes in accordance with implementations of the present disclosure. The UE may receive the CSI-RS and determine a precoder. The UE may determine Q=2 DFT basis vectors considering all layers from TD basis vector and report the DFT basis vectors in i_{1,10} and i_{1,4}. The network node may determine the TD basis vector using i_{1,10} and i_{1,4}.

In some embodiments, oversampling may be introduced for SD and FD compression, and higher granular information for SD and FD compression may be achieved. However, if the precoder construction is restricted to orthogonal basis vectors (e.g., restricted by fixing the offsets q₁, q₂, q₃ for all the selected SD and FD basis vectors), the peak performance may be limited and the higher granular information may not be fully utilized. Therefore, non-orthogonal SD and FD basis for compression may be introduced.

In some implementations, regarding the non-orthogonal SD and FD basis vectors, the oversampling offsets (e.g., q₁, q₂, q₃) may not be fixed to be same for all selected DFT basis vectors. In other words, the values of q₁, q₂ for the selected L SD basis vectors may be different. Therefore, the SD and FD basis vectors may have all the oversampled DFT basis vectors for compression, instead of the one with same offset.

In particular, the SD based DFT basis vector indices

$${m}_{1}^{( i )} , {m}_{2}^{( i )}$$

for non-orthogonal basis vectors may be represented by:

$${m}_{1}^{( i )} = {n}_{1}^{( i )} {O}_{1} + {q}_{1}^{( i )} , \qquad ( 2.9 )$$

$$where i ∈ \{ 0 , 1 , … , L - 1 \} , \\ {q}_{1}^{( i )} ∈ \{ 0 , 1 , … , {O}_{1} - 1 \} and {n}_{1}^{( i )} ∈ \{ 0 , 1 , … , {N}_{1} - 1 \} and$$

$${m}_{2}^{( i )} = {n}_{2}^{( i )} {O}_{2} + {q}_{2}^{( i )} , \qquad ( 2.1 )$$

$$where {q}_{2}^{( i )} ∈ \{ 0 , 1 , … , {O}_{2} - 1 \} and {n}_{2}^{( i )} ∈ \{ 0 , 1 , … , {N}_{2} - 1 \} .$$

The FD based DFT basis vector indices

$${m}_{3 , l}^{( f )}$$

for layer l with non-orthogonal basis vectors may be represented by:

$${m}_{3 , l}^{( f )} = {n}_{3 , l}^{( f )} {O}_{3} + {q}_{3 , l}^{( f )} , \qquad ( 2.11 )$$

$$where f ∈ \{ 0 , 1 , … , M - 1 \} , \\ {q}_{3 , l}^{( f )} ∈ \{ 0 , 1 , … , {O}_{3} - 1 \} and {n}_{3 , l}^{( f )} ∈ \{ 0 , 1 , … , {N}_{3} - 1 \} .$$

More specifically, the network node may enable the usage of the non-orthogonal basis vectors by setting the plurality of first parameters. For example, the network node may enable the usage of the non-orthogonal basis vectors by setting: (1) the non-orthogonal SD basis vector parameter (e.g., parameter named enableNonOrthogonalSDBasis); and/or (2) the non-orthogonal FD basis vector parameter (e.g., parameter named enableNonOrthogonalFDBasis); and/or (3) the non-orthogonal TD basis vector parameter (e.g., parameter named enableNonOrthogonalTDBasis) in CodebookConfig in the RRC configuration to “true”.

In some embodiments, the configuration may include the plurality of first parameters and the plurality of the second parameters. The plurality of first parameters may include the non-orthogonal SD basis vector parameter (e.g., enableNonOrthogonalSDBasis) and the non-orthogonal FD basis vector parameter (e.g., enableNonOrthogonalFDBasis). The plurality of the second parameters may include a value of a frequency oversampling factor (e.g., valueOfO3). The UE may determine the plurality of first non-orthogonal DFT vectors for SD compression for all layers according to the non-orthogonal SD basis vector parameter. The UE may determine the plurality of second non-orthogonal DFT vectors for FD compression per layer according to the non-orthogonal FD basis vector parameter and the value of the frequency oversampling factor. The network node may the plurality of first non-orthogonal DFT vectors and the plurality of second non-orthogonal DFT vectors from the UE and determine a precoder according to the plurality of first non-orthogonal DFT vectors and the plurality of second non-orthogonal DFT vectors.

More specifically, the common frequency domain basis vector parameter (e.g., enableCommonFDBasis) may be set to “false”. The non-orthogonal SD basis vector parameter (e.g., enableNonOrthogonalSDBasis) may be set to “true”, and L non-orthogonal DFT basis vectors for SD compression applicable for all the layers may be reported. The non-orthogonal FD basis vector parameter (e.g., enableNonOrthogonalFDBasis) may be set to “true”, and M non-orthogonal DFT basis vectors per layer for FD compression may be reported.

In some implementations, regarding precoder reporting of 3GPP eTypeII precoder, the following procedure may be performed:
when enableNonOrthogonalSDBasis is set to “true”,
   i_{1,1} may not be reported,
   the SD based DFT basis vector indices

$${m}_{1}^{( i )} , {m}_{2}^{( i )}$$

for i=0, . . . , L−1 may be reported in

$${i}_{1 , 2} ∈ \{ 0 , 1 , … , ( \begin{matrix}{N}_{1} {N}_{2} {O}_{1} {O}_{2} \\ L\end{matrix} ) - 1 \}$$

using the following procedure:
let

$${m}^{( i )} = {m}_{2}^{( i )} {N}_{1} {O}_{1} + {m}_{1}^{( i )} ,$$

where the indices i=0, 1, . . . , L−1 may be assigned such that m⁽ⁱ⁾ may increase as i increases
then

$${i}_{1 , 2} = {\sum }_{i = 0}^{L - 1} ( \begin{matrix}{N}_{1} {N}_{2} {O}_{1} {O}_{2} - 1 - {m}^{( i )} \\ L - i\end{matrix} ) ;$$

when enableNonOrthogonalSDBasis is not set to “true”,
   i_{1,1} & i_{1,2} may be reported according to precoder reporting of 3GPP eTypeII precoder under current CSI framework;
when enableNonOrthogonalFDBasis is set to “true”,
   the FD based DFT basis vector indices

$${m}_{3 , l}^{( f )} , f = 0 , … ,$$

M−1 may be reported in i_{1,6,l}∈

$$\{ 0 , 1 , … , ( \begin{matrix}{N}_{3} {O}_{3} \\ M\end{matrix} ) - 1 \} such that {i}_{1 , 6 , l} = {\sum }_{f = 0}^{M - 1} ( \begin{matrix}{N}_{3} {O}_{3} - 1 - {m}_{3 , l}^{( f )} \\ M - f\end{matrix} ) ;$$

and
when enableNonOrthogonalFDBasis is not set to “true”,
   i_{1,3} & i_{1,6,l} may be reported according to previous sections of introducing oversampling for FD and TD basis vector.

In some implementations, regarding precoder reconstruction of 3GPP eTypeII precoder, the following procedure may be performed:
when enableNonOrthogonalSDBasis is set to “true”,
   the SD based DFT basis vector indices

$${m}_{1}^{( i )} , {m}_{2}^{( i )}$$

for i=0, . . . , L−1 may be retrieved from i_{1,2} using the following procedure:

$${s}_{- 1} = 0$$

for i=0, 1, . . . , L−1
   find the largest x*∈{L−1−i, . . . , N₁N₂O₁O₂−1−i} such that i_{1,2}−sᵢ₋₁≥C(x*, L−i) where C(x, y) is represented in the equation (1.7)

$${e}_{i} = C ( {x}^{*} , L - i )$$

$${s}_{i} = {s}_{i - 1} + {e}_{i}$$

$${m}^{( i )} = {N}_{1} {N}_{2} {O}_{1} {O}_{2} - 1 - {x}^{*}$$

$${m}_{1}^{( i )} = {m}^{( i )} mod {N}_{1} {O}_{1}$$

$${m}_{2}^{( i )} = \frac{( {m}^{( i )} - {m}_{1}^{( i )} )}{{N}_{1} {O}_{1}} ;$$

when enableNonOrthogonalSDBasis is not set to “true”,

$${m}_{1}^{( i )} , {m}_{2}^{( i )}$$

may be computed according to precoder reconstruction of 3GPP eTypeII precoder under current CSI framework;
when enableNonOrthogonalFDBasis is set to “true”,
   the FD DFT vector indices

$${m}_{3 , l}^{( f )} ,$$

$$f = 0 , … ,$$

M−1 may be retrieved from i_{1,6,l} using the following procedure:

$${s}_{- 1} = 0$$

$$for$$

$$f = 0 , … ,$$

$$M - 1$$

find the largest x*∈{M−1−f, . . . , N₃O₃−1−f} such that i_{1,6,l}−s_{f-1}≥C(x*,M−f) where C(x,y) is represented in the equation (1.7)

$${e}_{f} = C ( {x}^{*} , M - f )$$

$${s}_{f} = {s}_{f - 1} + {e}_{f}$$

$${m}_{3 , l}^{( f )} = {N}_{3} {O}_{3} - 1 - {x}^{*} ;$$

when enableNonOrthogonalFDBasis is not set to “true”,

$${n}_{3 , l}^{( f )}$$

and q₃ may be computed according to previous sections of introducing oversampling for FD and TD basis vector.

In some implementations, regarding UCI bit width calculation of 3GPP eTypeII precoder, the bit width may be determined based on the following table:

| | | Non-orthogonal | Non-orthogonal | Non-orthogonal |
|---|---|---|---|---|
| | Parameter | SD bit width | FD bit width | SD&FD bit width |
| | i_{1,1} | 0 | ┌log₂(O₁O₂)┐ | 0 |
| | i_{1,2} | $⌈ {log}_{2} ( \begin{matrix}{N}_{1} {N}_{2} {O}_{1} {O}_{2} \\ L\end{matrix} ) ⌉$ | $⌈ {log}_{2} ( \begin{matrix}{N}_{1} {N}_{2} \\ L\end{matrix} ) ⌉$ | $⌈ {log}_{2} ( \begin{matrix}{N}_{1} {N}_{2} {O}_{1} {O}_{2} \\ L\end{matrix} ) ⌉$ |
| These are reported per layer | i_{1,3,l} | ┌log₂(O₃)┐ | 0 | 0 |
| | i_{1,6,l} | $⌈ {log}_{2} ( \begin{matrix}{N}_{3} \\ M\end{matrix} ) ⌉$ | $⌈ {log}_{2} ( \begin{matrix}{N}_{3} {O}_{3} \\ M\end{matrix} ) ⌉$ | $⌈ {log}_{2} ( \begin{matrix}{N}_{3} {O}_{3} \\ M\end{matrix} ) ⌉$ |
| | i_{1,7,l} | 2LM | 2LM | 2LM |
| | i_{1,8,l} | ┌log₂(2L)┐ | ┌log₂(2L)┐ | ┌log₂(2L)┐ |
| | ${K}_{l}^{NZ}$ | ┌log₂(┌2βLM┐)┐ | ┌log₂(┌2βLM┐)┐ | ┌log₂(┌2βLM┐)┐ |
| | i_{2,3,l} | 4 | 4 | 4 |
| | i_{2,4,l} | $3 ( {K}_{l}^{NZ} - 1 )$ | $3 ( {K}_{l}^{N Z} - 1 )$ | $3 ( {K}_{l}^{N Z} - 1 )$ |
| | i_{2,5,l} | $4 ( {K}_{l}^{N Z} - 1 )$ | $4 ( {K}_{l}^{N Z} - 1 )$ | $4 ( {K}_{l}^{N Z} - 1 )$ |

In some implementations, regarding precoder reporting of 3GPP eTypeII precoder for C-JT, the following procedure may be performed:
when enableNonOrthogonalSDBasis is set to “true”,
   i_{1,1} may not be reported,
   the SD based DFT basis vector indices

$${m}_{1 , j}^{( i )} ,$$

$${m}_{2 , j}^{( i )}$$

for i=0, . . . , L_{σ}_{ⱼ}−1 may be reported in

$${i}_{1 , 2 , j} ∈ \{ 0 , 1 , … , ( {{N}_{1} {N}_{2} {O}_{1} {O}_{2}}_{{L}_{{σ}_{j}}} ) - 1 \}$$

using the following procedure:
let

$${m}_{j}^{( i )} = {m}_{2 , j}^{( i )} {N}_{1} {0}_{1} + {m}_{1 , j}^{( i )} ,$$

where the indices i=0, 1, . . . , L_{σ}_{ⱼ}−1 may be assigned
such that m⁽ⁱ⁾ may increase as i increases,
then

$${i}_{1 , 2 , j} = {\sum }_{i = 0}^{{L}_{{σ}_{j}} - 1} ( {{N}_{1} {N}_{2} {O}_{1} {O}_{2} - 1 - {m}_{j}^{( i )}}_{{L}_{{σ}_{j}} - i} ) ;$$

when enableNonOrthogonalSDBasis is not set to “true”,
   i_{1,1} & i_{1,2} may be reported according to precoder reporting of 3GPP eTypeII precoder for CJ-T under current CSI framework;
when enableNonOrthogonalFDBasis is set to “true”,
   the FD based DFT basis vector indices

$${m}_{3 , l}^{( f )} ,$$

$$f = 0 , … ,$$

M−1 may be reported in i_{1,6,l}∈

$$\{ 0 , 1 , … , ( \begin{matrix}{N}_{3} {O}_{3} \\ M\end{matrix} ) - 1 \}$$

such that

$${i}_{1 , 6 , l} = {\sum }_{f = 0}^{M - 1} ( \begin{matrix}{N}_{3} {O}_{3} - 1 - {m}_{3 , l}^{( f )} \\ M - f\end{matrix} ) ;$$

when enableNonOrthogonalFDBasis is not set to “true”,
   i_{1,3} & i_{1,6,l} is reported according to previous sections of introducing oversampling for FD and TD basis vector.

In some implementations, regarding precoder reconstruction of 3GPP eTypeII precoder for CJ-T, the following procedure may be performed:
when enableNonOrthogonalSDBasis is set to “true”,
   the SD based DFT basis vector indices

$${m}_{1 , j}^{( i )} ,$$

$${m}_{2 , j}^{( i )}$$

for i=0, . . . , L_{σ}_{ⱼ}−1 may be retrieved from i_{1,2,j} using the following procedure:

$${s}_{- 1} = 0$$

for i=0, 1, . . . , L_{σ}_{ⱼ}−1
   find the largest x*∈{L_{σ}_{ⱼ}−1−i, . . . , N₁N₂O₁O₂−1−i} such that i_{1,2}−sᵢ₋₁≥C(x*,L_{σ}_{ⱼ}−i) where C(x,y) is represented in the equation (1.7)

$${e}_{i} = C ( {x}^{*} , {L}_{{σ}_{j}} - i )$$

$${s}_{i} = {s}_{i - 1} + {e}_{i}$$

$${m}_{j}^{( i )} = {N}_{1} {N}_{2} {O}_{1} {O}_{2} - 1 - {x}^{*}$$

$${m}_{1 , j}^{( i )} = {m}_{j}^{( i )} mod {N}_{1} {O}_{1}$$

$${m}_{2 , j}^{( i )} = \frac{( {m}_{j}^{( i )} - {m}_{1 , j}^{( i )} )}{{N}_{1} {O}_{1}} ;$$

when enableNonOrthogonalSDBasis is not set to “true”,

$${m}_{1}^{( i )} , {m}_{2}^{( i )}$$

may be computed according to precoder reconstruction of 3GPP eTypeII precoder for CJ-T under current CSI framework;
when enableNonOrthogonalFDBasis is not set to “true”,
   the FD based DFT basis vector indices

$${m}_{3 , l}^{( f )} ,$$

for f=0, . . . , M−1 may be retrieved from i_{1,6,l} using the following procedure:

$${s}_{- 1} = 0$$

for f=0, . . . , M−1
   find the largest x*∈{M−1−f, . . . , N₃O₃−1−f} such that i_{1,6,l}−s_{f-1}≥C(x*,M−f) where C(x, y) is represented in the equation (7)

$${e}_{f} = C ( {x}^{*} , M - f )$$

$${s}_{f} = {s}_{f - 1} + {e}_{f}$$

$${m}_{3 , l}^{( f )} = {N}_{3} {O}_{3} - 1 - {x}^{*} ;$$

when enableNonOrthogonalFDBasis is set to “true”.

$${n}_{3 , l}^{( f )}$$

and q₃ may be computed according to previous sections of introducing oversampling for FD and TD basis vector.

In some implementations, regarding UCI bit width calculation of 3GPP eTypeII precoder for CJ-T, the bit width may be determined based on the following table

$$( considering L = {\sum }_{j = 1}^{N} {L}_{{σ}_{j}} ) :$$

| | | Non-orthogonal | Non-orthogonal | Non-orthogonal |
|---|---|---|---|---|
| | Parameter | SD bit width | FD bit width | SD&FD bit width |
| | i_{1,1} | 0 | ┌log₂(O₁O₂)┐ | 0 |
| | i_{1,2} | ${\sum }_{j = 1}^{N} ⌈ {log}_{2} ( \begin{matrix}{N}_{1} {N}_{2} {O}_{1} {O}_{2} \\ {L}_{{σ}_{j}}\end{matrix} ) ⌉$ | ${\sum }_{j = 1}^{N} ⌈ {log}_{2} ( \begin{matrix}{N}_{1} {N}_{2} \\ {L}_{{σ}_{j}}\end{matrix} ) ⌉$ | ${\sum }_{j = 1}^{N} ⌈ {log}_{2} ( \begin{matrix}{N}_{1} {N}_{2} {O}_{1} {O}_{2} \\ {L}_{{σ}_{j}}\end{matrix} ) ⌉$ |
| These are reported per layer | i_{1,3,l} | ┌log₂(O₃)┐ | 0 | 0 |
| | i_{1,6,l} | $⌈ {log}_{2} ( \begin{matrix}{N}_{3} \\ M\end{matrix} ) ⌉$ | $⌈ {log}_{2} ( \begin{matrix}{N}_{3} {O}_{3} \\ M\end{matrix} ) ⌉$ | $⌈ {log}_{2} ( \begin{matrix}{N}_{3} {O}_{3} \\ M\end{matrix} ) ⌉$ |
| | i_{1,7,l} | 2LM | 2LM | 2LM |
| | i_{1,8,l} | ┌log₂(2L)┐ | ┌log₂(2L)┐ | ┌log₂(2L)┐ |
| | ${K}_{l}^{NZ}$ | ┌log₂(┌2βLM┐)┐ | ┌log₂(┌2βLM┐)┐ | ┌log₂(┌2βLM┐)┐ |
| | i_{2,3,l} | 4 | 4 | 4 |
| | i_{2,4,l} | $3 ( {K}_{l}^{N Z} - 1 )$ | $3 ( {K}_{l}^{N Z} - 1 )$ | $3 ( {K}_{l}^{N Z} - 1 )$ |
| | i_{2,5,l} | $4 ( {K}_{l}^{N Z} - 1 )$ | $4 ( {K}_{l}^{N Z} - 1 )$ | $4 ( {K}_{l}^{N Z} - 1 )$ |

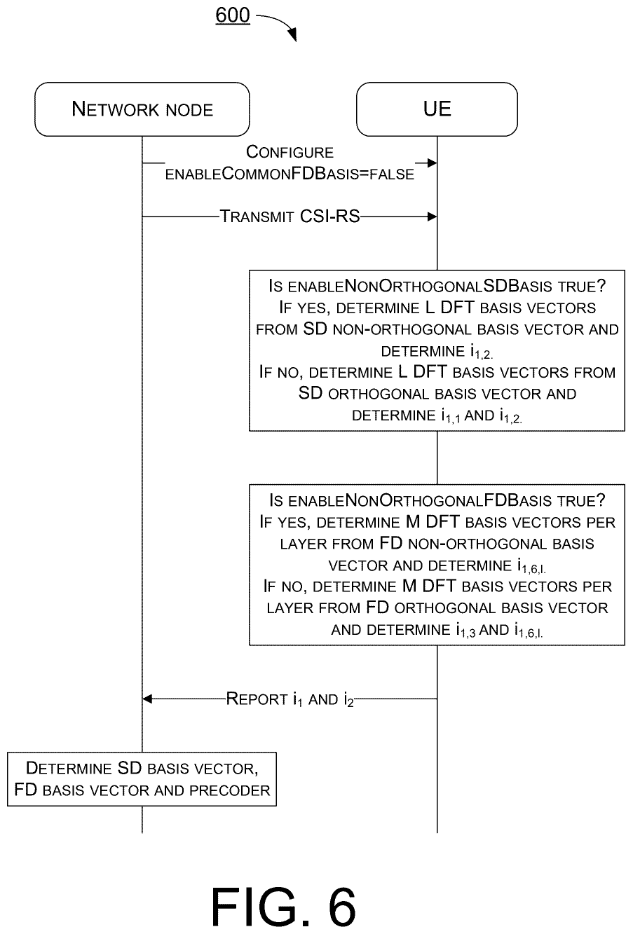

Regarding the above eTypeII precoder compression with non-orthogonal basis vector and per-layer FD reporting, FIG. 6 illustrates an example scenario 600 under schemes in accordance with implementations of the present disclosure. The network node may configure enableCommonFDbasis=false. The UE may receive the CSI-RS and determine a precoder. The UE may determine whether enableNonOrthogonalSDBasis in the RRC configuration is true. If enableNonOrthogonalSDBasis is set as true, the UE may determine L DFT basis vectors from SD non-orthogonal basis vector and determine i_{1,2}. If enableNonOrthogonalSDBasis is set as false, the UE may determine L DFT basis vectors from SD orthogonal basis vector and determine i_{1,1} and i_{1,2}. The UE may determine whether enableNonOrthogonalFDBasis in the RRC configuration is true. If enableNonOrthogonalFDBasis is set as true, the UE may determine M DFT basis vectors per layer from FD non-orthogonal basis vector and determine i_{1,6,l}. If enableNonOrthogonalFDBasis is set as false, the UE may determine M DFT basis vectors per layer from FD orthogonal basis vector and determine i_{1,3} and i_{1,6,l}. The UE may report i₁ and i₂. The network node may determine the SD basis vector, the FD basis vector and the precoder.

In some embodiments, the configuration may include the plurality of first parameters, the plurality of second parameters and the plurality of fourth parameters. The plurality of first parameters may include the non-orthogonal SD basis vector parameter (e.g., enableNonOrthogonalSDBasis) and the non-orthogonal FD basis vector parameter (e.g., enableNonOrthogonalFDBasis). The plurality of the second parameter may include a frequency oversampling parameter (e.g., frequencyOversampling) and a value of a frequency oversampling factor (e.g., valueOfO3). The plurality of fourth parameters may include the common FD basis vector parameter (e.g., enableCommonFDBasis); and the common frequency domain offset parameter (e.g., parameter named enableCommonFDOffset). The UE may determine a plurality of first non-orthogonal DFT vectors for SD compression for all layers according to the non-orthogonal SD basis vector parameter and determine a plurality of second non-orthogonal DFT vectors for FD compression for all layers according to the non-orthogonal FD basis vector parameter, the frequency oversampling parameter, the value of the frequency oversampling factor, the common FD basis vector parameter and the common FD offset parameter. The network node may receive the plurality of first non-orthogonal DFT vectors and the plurality of second non-orthogonal DFT vectors from the UE and determine a precoder according to the plurality of first non-orthogonal DFT vectors and the plurality of second non-orthogonal DFT vectors.

More specifically, the common frequency domain offset parameter (e.g., enableCommonFDOffset) may be set to “true”. The non-orthogonal SD basis vector parameter (e.g., enableNonOrthogonalSDBasis) may be set to “true”, and L non-orthogonal DFT basis vectors for SD compression applicable for all the layers may be reported. The non-orthogonal FD basis vector parameter (e.g., enableNonOrthogonalFDBasis) may be set to “true”, and M non-orthogonal DFT basis vectors for FD compression applicable for all the layers may be reported.

In some implementations, regarding precoder reporting of 3GPP eTypeII precoder, the following procedure may be performed:
when enableNonOrthogonalSDBasis is set to “true”,
   i_{1,1} may not be reported,
   the SD based DFT basis vector indices

$${m}_{1}^{( i )} , {m}_{2}^{( i )}$$

for i=0, . . . , L−1 may be reported in

$${i}_{1 , 2} ∈ \{ 0 , 1 , … , ( \begin{matrix}{N}_{1} {N}_{2} {O}_{1} {O}_{2} \\ L\end{matrix} ) - 1 \}$$

using the following procedure:
let

$${m}^{( i )} = {m}_{2}^{( i )} {N}_{1} {O}_{1} + {m}_{1}^{( i )} ,$$

where the indices i=0, 1, . . . , L−1 may be assigned such that m⁽ⁱ⁾ may increase as i increases,
then

$${i}_{1 , 2} = {\sum }_{i = 0}^{L - 1} ( \begin{matrix}{N}_{1} {N}_{2} {O}_{1} {O}_{2} - 1 - {m}^{( i )} \\ L - i\end{matrix} ) ;$$

when enableNonOrthogonalSDBasis is not set to “true”,
   i_{1,1} & i_{1,2} may be reported according to precoder reporting of 3GPP eTypeII precoder under current CSI framework;
when enableNonOrthogonalFDBasis is set to “true”,
   the DFT vector indices

$${m}_{3 , l}^{( f )} ,$$

i_{1,6,l} ale same for an layers and are replaced by

$${m}_{3}^{( f )} ,$$

i_{1,6} respectively;
the FD DFT vector indices

$${m}_{3}^{( f )} ,$$

f=0, . . . , M−1 are reported in

$${i}_{1 , 6} ∈ \{ 0 , 1 , … , ( \begin{matrix}{N}_{3} {O}_{3} \\ M\end{matrix} ) - 1 \}$$

such that

$${i}_{1 , 6} = {\sum }_{f = 0}^{M - 1} ( \begin{matrix}{N}_{3} {O}_{3} - 1 - {m}_{3}^{( f )} \\ M - f\end{matrix} ) ;$$

when enableNonOrthogonalFDBasis is not set to “true”,
   i_{1,3} and i_{1,6} may be reported according to previous sections of introducing the common TD and FD basis vector.

In some implementations, regarding precoder reconstruction of 3GPP eTypeII precoder, the following procedure may be performed:
when enableNonOrthogonalSDBasis is set to “true”,
   the SD based DFT basis vector indices

$${m}_{1}^{( i )} , {m}_{2}^{( i )}$$

for i=0, . . . , L−1 may be retrieved from i_{1,2} using the following procedure:

$${s}_{- 1} = 0$$

for i=0, 1, . . . , L−1
   find the largest x*∈{L−1−i, . . . , N₁N₂O₁O₂−1−i} such that i_{1,2}−sᵢ₋₁≥C(x*,L−i) where C(x,y) is represented in the equation (1.7)

$${e}_{i} = C ( {x}^{*} , L - i )$$

$${s}_{i} = {s}_{- 1} + {e}_{i}$$

$${m}^{( i )} = {N}_{1} {N}_{2} {O}_{1} {O}_{2} - 1 - {x}^{*}$$

$${m}_{1}^{( i )} = {m}^{( i )} mod {N}_{1} {O}_{1}$$

$${m}_{2}^{( i )} = \frac{( {m}^{( i )} - {m}_{1}^{( i )} )}{{N}_{1} {O}_{1}} ;$$

when enableNonOrthogonalSDBasis is not set to “true”,

$${m}_{1}^{( i )} , {m}_{2}^{( i )}$$

may be computed according to precoder reconstruction of 3GPP eTypeII precoder under current CSI framework;
when enableNonOrthogonalFDBasis is set to “true”,
   the FD DFT vector indices

$${m}_{3}^{( f )} ,$$

f=0, . . . , M−1 are retrieved from i_{1,6} using the following procedure:

$${s}_{- 1} = 0$$

for f=0, . . . , M−1
   find the largest x*∈{M−1−f, . . . , N₃O₃−1−f} such that i_{1,6}−s_{f-1}≥C(x*,M−f) where C(x,y) is represented in the equation (1.7)

$${e}_{f} = C ( {x}^{*} , M - f )$$

$${s}_{f} = {s}_{f - 1} + {e}_{f}$$

$${m}_{3}^{( f )} = {N}_{3} {O}_{3} - 1 - {x}^{*} ;$$

when enableNonOrthogonalFDBasis is not set to “true”,

$${m}_{3}^{( f )}$$

may be company avoiding to previous sections of introducing the common TD and FD basis vector.

In some implementations, regarding UCI bit width calculation of 3GPP eTypeII precoder, the bit width may be determined based on the following table:

| | | Non-orthogonal | Non-orthogonal | Non-orthogonal |
|---|---|---|---|---|
| | Parameter | SD bit width | FD bit width | SD&FD bit width |
| | i_{1,1} | 0 | ┌log₂(O₁O₂)┐ | 0 |
| | i_{1,2} | $⌈ {log}_{2} ( \begin{matrix}{N}_{1} {N}_{2} {O}_{1} {O}_{2} \\ L\end{matrix} ) ⌉$ | $⌈ {log}_{2} ( \begin{matrix}{N}_{1} {N}_{2} \\ L\end{matrix} ) ⌉$ | $⌈ {log}_{2} ( \begin{matrix}{N}_{1} {N}_{2} {O}_{1} {O}_{2} \\ L\end{matrix} ) ⌉$ |
| | i_{1,3} | ┌log₂(O₃)┐ | 0 | 0 |
| | i_{1,6} | $⌈ {log}_{2} ( \begin{matrix}{N}_{3} \\ M\end{matrix} ) ⌉$ | $⌈ {log}_{2} ( \begin{matrix}{N}_{3} {O}_{3} \\ M\end{matrix} ) ⌉$ | $⌈ {log}_{2} ( \begin{matrix}{N}_{3} {O}_{3} \\ M\end{matrix} ) ⌉$ |
| These are reported per layer | i_{1,7,l} | 2LM | 2LM | 2LM |
| | i_{1,8,l} | ┌log₂(2L)┐ | ┌log₂(2L)┐ | ┌log₂(2L)┐ |
| | ${K}_{l}^{NZ}$ | ┌log₂(┌2βLM┐)┐ | ┌log₂(┌2βLM┐)┐ | ┌log₂(┌2βLM┐)┐ |
| | i_{2,3,l} | 4 | 4 | 4 |
| | i_{2,4,l} | $3 ( {K}_{l}^{N Z} - 1 )$ | $3 ( {K}_{l}^{N Z} - 1 )$ | $3 ( {K}_{l}^{N Z} - 1 )$ |
| | i_{2,5,l} | $4 ( {K}_{l}^{N Z} - 1 )$ | $4 ( {K}_{l}^{N Z} - 1 )$ | $4 ( {K}_{l}^{N Z} - 1 )$ |

In some implementations, regarding UCI bit width calculation of 3GPP eTypeII precoder for CJ-T, the bit width may be determined based on the following table

$$( considering L = {\sum }_{j = 1}^{N} {L}_{{σ}_{j}} ) :$$

| | | Non-orthogonal | Non-orthogonal | Non-orthogonal |
|---|---|---|---|---|
| | Parameter | SD bit width | FD bit width | SD&FD bit width |
| | i_{1,1} | 0 | ┌log₂(O₁O₂)┐ | 0 |
| | i_{1,2} | ${\sum }_{j = 1}^{N} ⌈ {log}_{2} ( \begin{matrix}{N}_{1} {N}_{2} {O}_{1} {O}_{2} \\ {L}_{{σ}_{j}}\end{matrix} ) ⌉$ | ${\sum }_{j = 1}^{N} ⌈ {log}_{2} ( \begin{matrix}{N}_{1} {N}_{2} \\ {L}_{{σ}_{j}}\end{matrix} ) ⌉$ | ${\sum }_{j = 1}^{N} ⌈ {log}_{2} ( \begin{matrix}{N}_{1} {N}_{2} {O}_{1} {O}_{2} \\ {L}_{{σ}_{j}}\end{matrix} ) ⌉$ |
| | i_{1,3} | ┌log₂(O₃)┐ | 0 | 0 |
| | i_{1,6} | $⌈ {log}_{2} ( \begin{matrix}{N}_{3} \\ M\end{matrix} ) ⌉$ | $⌈ {log}_{2} ( \begin{matrix}{N}_{3} {O}_{3} \\ M\end{matrix} ) ⌉$ | $⌈ {log}_{2} ( \begin{matrix}{N}_{3} {O}_{3} \\ M\end{matrix} ) ⌉$ |
| These are reported per layer | i_{1,7,l} | 2LM | 2LM | 2LM |
| | i_{1,8,l} | ┌log₂(2L)┐ | ┌log₂(2L)┐ | ┌log₂(2L)┐ |
| | ${K}_{l}^{NZ}$ | ┌log₂(┌2βLM┐)┐ | ┌log₂(┌2βLM┐)┐ | ┌log₂(┌2βLM┐)┐ |
| | i_{2,3,l} | 4 | 4 | 4 |
| | i_{2,4,l} | $3 ( {K}_{l}^{N Z} - 1 )$ | $3 ( {K}_{l}^{N Z} - 1 )$ | $3 ( {K}_{l}^{N Z} - 1 )$ |
| | i_{2,5,l} | $4 ( {K}_{l}^{N Z} - 1 )$ | $4 ( {K}_{l}^{N Z} - 1 )$ | $4 ( {K}_{l}^{N Z} - 1 )$ |

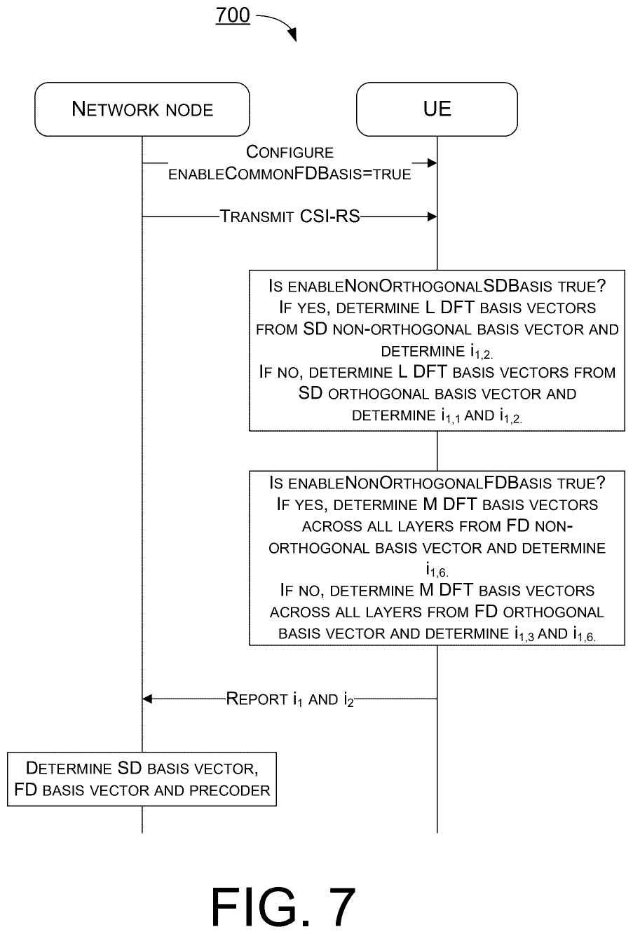

Regarding the above eTypeII precoder compression with non-orthogonal basis vector and layer-common FD reporting, FIG. 7 illustrates an example scenario 700 under schemes in accordance with implementations of the present disclosure. The network node may configure enableCommonFDbasis=true. The UE may receive the CSI-RS and determine a precoder. The UE may determine whether enableNonOrthogonalSDBasis in the RRC configuration is true. If enableNonOrthogonalSDBasis is set as true, the UE may determine L DFT basis vectors from SD non-orthogonal basis vector and determine i_{1,2}. If enableNonOrthogonalSDBasis is set as false, the UE may determine L DFT basis vectors from SD orthogonal basis vector and determine i_{1,1} and. i_{1,2}. The UE may determine whether enableNonOrthogonalFDBasis in the RRC configuration is true. If enableNonOrthogonalFDBasis is set as true, the UE may determine M DFT basis vectors across all layers from FD non-orthogonal basis vector and determine i_{1,6}. If enableNonOrthogonalFDBasis is set as false, the UE may determine M DFT basis vectors across all layers from FD orthogonal basis vector and determine i_{1,3} and i_{1,6}. The UE may report i₁ and i₂. The network node may determine the SD basis vector, the FD basis vector and the precoder.

In some embodiments, the configuration may include the plurality of first parameters, the plurality of second parameters, the plurality of third parameters and the plurality of fourth parameters. The plurality of first parameters may include the non-orthogonal SD basis vector parameter (e.g., enableNonOrthogonalSDBasis) and a non-orthogonal frequency domain basis vector parameter (e.g., enableNonOrthogonalFDBasis). The plurality of second parameters may include a frequency oversampling parameter (e.g., frequencyOversampling) and a value of a frequency oversampling factor (e.g., valueOfO3). The plurality of third parameters may include the composite SD and FD basis vector parameter (e.g., enableCompositeSDFDBasis). The plurality of fourth parameters may include the common FD basis vector parameter (e.g., enableCommonFDBasis). The UE may determine a plurality of composite vectors which is composite of non-orthogonal SD basis vectors and non-orthogonal FD basis vectors according to the composite SD and FD basis vector parameter, the non-orthogonal SD basis vector parameter, the non-orthogonal FD basis vector parameter, the frequency oversampling parameter and the value of the frequency oversampling factor. The network node may receive the plurality of composite vectors from the UE and determine a precoder according to the plurality of composite vectors.

More specifically, the composite SD and FD basis vector parameter (e.g., enableCompositeSDFDBasis) may be set to “true”. The value K of number of basis vectors selected for composite may be configured by using a parameter valueOfK of the plurality of third parameters. The common frequency domain basis vector parameter (e.g., enableCommonFDBasis) may be set to “true”. The non-orthogonal SD basis vector parameter (e.g., enableNonOrthogonalSDBasis) may be set to “true”. The non-orthogonal FD basis vector parameter (e.g., enableNonOrthogonalFDBasis) may be set to “true”. In some cases, the composite SD and FD basis vectors may be formed by performing Kronecker product of full non-orthogonal SD and FD basis vectors. The K vectors to be reported may be selected in the composite SD and FD basis vectors.

In some implementations, regarding precoder reporting of 3GPP eTypeII precoder, c^{th} column of the common SD and FD basis vector may be formed by Kronecker product of a^{th} column of FD basis vector and b^{th} column of the SD basis vector, such that c=a*N₁O₁N₂O₂+b,
where c∈{0, 1, . . . , N₁N₂N₃O₁O₂O₃−1}, a∈{0, 1, . . . , N₃O₃−1} and
b∈{0, 1, . . . , N₁N₂O₁O₂−1},
let cₖ be the index of the k^{th} column of the selected composite basis,
where k∈{0, 1, . . . , K−1} such that

$${c}_{k} = {m}_{3}^{( k )} * {N}_{1} {O}_{1} {N}_{2} {O}_{2} + {m}^{( k )} ;$$

$${m}^{( k )} = {m}_{2}^{( k )} {N}_{1} {O}_{1} + {m}_{1}^{( k )} , where {m}^{( k )} ∈ \{ 0 , 1 , … , {N}_{1} {N}_{2} {O}_{1} {O}_{2} - 1 \} ;$$

$${m}_{1}^{( k )} = {n}_{1}^{( k )} {O}_{1} + {q}_{1}^{( k )} , where {q}_{1}^{( k )} ∈ \{ 0 , 1 , … , {O}_{1} - 1 \} and {n}_{1}^{( k )} ∈ \{ 0 , 1 , … , {N}_{1} - 1 \} ;$$

$${m}_{2}^{( k )} = {n}_{2}^{( k )} {O}_{2} + {q}_{2}^{( k )} , where {q}_{2}^{( k )} ∈ \{ 0 , 1 , … , {O}_{2} - 1 \} and {n}_{2}^{( k )} ∈ \{ 0 , 1 , … , {N}_{2} - 1 \} ; and$$

$${m}_{3}^{( k )} = {n}_{3}^{( k )} {O}_{3} + {q}_{3}^{( k )} , where {q}_{3}^{( k )} ∈ \{ 0 , 1 , … , {O}_{3} - 1 \} and {n}_{3}^{( k )} ∈ \{ 0 , 1 , … , {N}_{3} - 1 \} ,$$

$$where {m}_{1}^{( k )} ∈ \{ 0 , 1 , … , {N}_{1} {O}_{1} - 1 \} , {m}_{2}^{( k )} ∈ \{ 0 , 1 , … , {N}_{2} {O}_{2} - 1 \} and$$

$${m}_{3}^{( k )} ∈ \{ 0 , 1 , … , {N}_{3} {O}_{3} - 1 \} .$$

The values of cₖ may be reported by using

$${i}_{1 , 2} ∈ \{ 0 , 1 , … , ( \begin{matrix}{N}_{1} {N}_{2} {N}_{3} {O}_{1} {O}_{2} {O}_{3} \\ K\end{matrix} ) - 1 \}$$

using following procedure:
the values of cy may be arranged such that cy may increase as k increases,
then

$${i}_{1 , 2} = {\sum }_{i = 0}^{K - 1} ( \begin{matrix}{N}_{1} {N}_{2} {N}_{3} {O}_{1} {O}_{2} {O}_{3} - 1 - {c}_{k} \\ K - i\end{matrix} ) .$$

The UE may select K₀=[β2Kv] coefficients and the selected coefficients may be reported in i_{1,7}. The amplitude and phase coefficients of K₀ coefficients may be reported in i_{2,4}, i_{2,5} similar to 3GPP eTypeII precoder under current CSI framework.

In some implementations, regarding precoder reconstruction of 3GPP eTypeII precoder, the values of cₖ may be retrieved from i_{1,2} by using the following procedure:

$${s}_{- 1} = 0$$

for k=0, 1, . . . , K−1
   find the largest x*∈{K−1−k, . . . , N₁N₂N₃O₁O₂O₃−1−k} such that i_{1,2}−sₖ₋₁≥

$$C ( {x}^{*} , K - k )$$

$${e}_{k} = C ( {x}^{*} , K - k )$$

$${s}_{k} = {s}_{k - 1} + {e}_{k}$$

$${c}_{k} = {N}_{1} {N}_{2} {N}_{3} {O}_{1} {O}_{2} {O}_{3} - 1 - {x}^{*} .$$

In some implementations, regarding UCI bit width calculation of 3GPP eTypeII precoder, the bit width may be determined based on the following table:

| Parameter | Bit Width |
|---|---|
| i_{1,2} | $⌈ {log}_{2} ( \begin{matrix}{N}_{1} {N}_{2} {O}_{1} {O}_{2} {N}_{3} {O}_{3} \\ K\end{matrix} ) ⌉$ |
| i_{1,7} | 2Kv |
| i_{1,8} | ┌log₂(2K)┐ |
| K^{NZ} | ┌log₂(┌2βkv┐)┐ |
| i_{2,4} | $3 ( {K}^{NZ} - 1 )$ |
| i_{2,5} | 4(K^{NZ} − 1) |

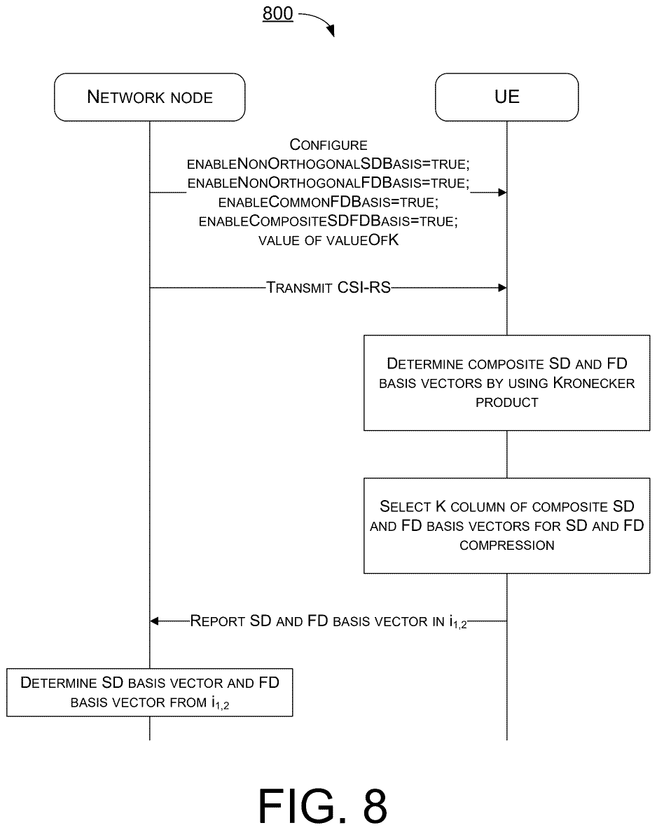

Regarding the above eTypeII precoder compression with non-orthogonal basis vector and composite SD and FD reporting, FIG. 8 illustrates an example scenario 800 under schemes in accordance with implementations of the present disclosure. The network node may configure: (1) enableNonOrthogonalSDBasis as true; (2) enableNonOrthogonalFDBasis as true; (3) enableCommonFDBasis as true; (4) enableCompositeSDFDBasis as true; and (5) value of valueOfK in the RRC configuration. The UE may receive the CSI-RS and determine a precoder. The UE may determine the composite SD and FD basis vectors by using Kronecker product. The UE may select K columns of the composite SD and FD basis vectors for SD and FD compression. The UE may report the SD and FD basis vectors in i_{1,2}. The network node may determine the SD and FD basis vectors from i_{1,2}.

In some embodiments, the configuration may include the plurality of first parameters and the plurality of second parameters. The plurality of first parameters may include the non-orthogonal SD basis vector parameter (e.g., enableNonOrthogonalSDBasis), the non-orthogonal FD basis vector parameter (e.g., enableNonOrthogonalFDBasis) and the non-orthogonal TD basis vector parameter (e.g., enableNonOrthogonalTDBasis). The plurality of the second parameters may include a frequency oversampling factor (e.g., O₃) and a time oversampling factor (e.g., O₄). The UE may determine: (1) a plurality of first non-orthogonal DFT vectors for SD compression for all layers according to the non-orthogonal SD basis vector parameter; (2) a plurality of second non-orthogonal DFT vectors FD compression per layer according to the non-orthogonal FD basis vector parameter and a value of the frequency oversampling factor; and (3) a plurality of third non-orthogonal DFT vectors for TD compression per layer according to the non-orthogonal TD basis vector parameter and a value of the time oversampling factor. The network node may receive the plurality of first non-orthogonal DFT vectors, the plurality of second non-orthogonal DFT vectors and the plurality of third non-orthogonal DFT vectors from the UE, and determine a precoder according to the plurality of first non-orthogonal DFT vectors, the plurality of second non-orthogonal DFT vectors and the plurality of third non-orthogonal DFT vectors.

More specifically, the TD based DFT basis vector indices

$${m}_{4 , l}^{( τ )}$$

for layer l will non-orthogonal basis vector may be represented by:

$${m}_{4 , l}^{( τ )} = {n}_{4 , l}^{( τ )} {O}_{4} + {q}_{4 , l} , and τ = 0 , 1. \& {n}_{4 , l}^{( τ )} ∈ \{ 0 , 1 , … , {N}_{4} - 1 \} .$$

The usage of the non-orthogonal basis vector may be extended by directly reporting

$${m}_{4 , l}^{( τ )} ∈ \{ 0 , 1 , … , {N}_{4} {O}_{4} - 1 \}$$

when the non-orthogonal TD basis vector parameter (e.g., enable NonOrthogonalTDBasis) is set to “true”.

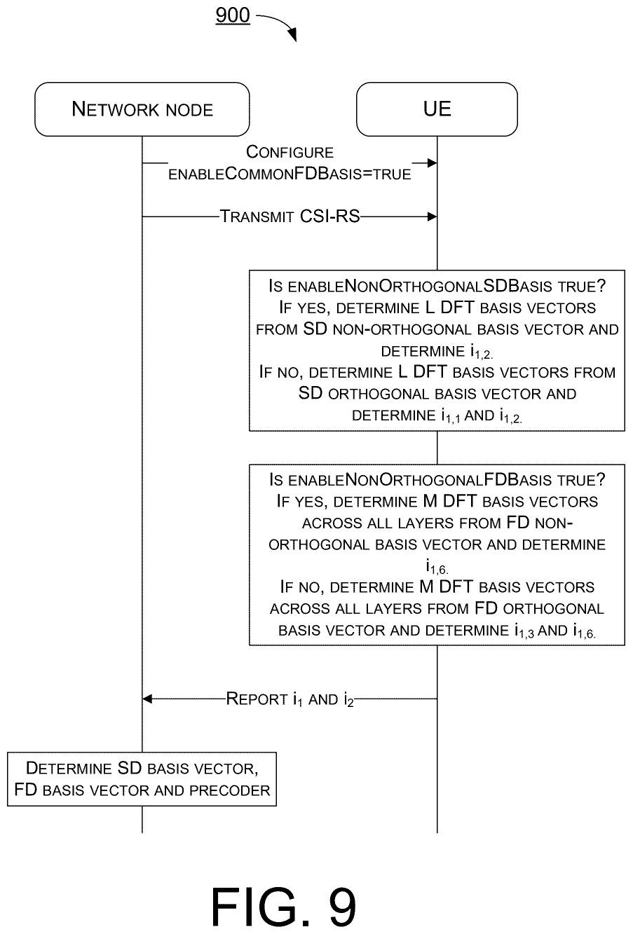

Regarding the above eTypeII precoder compression with non-orthogonal basis vector in TD, FIG. 9 illustrates an example scenario 900 under schemes in accordance with implementations of the present disclosure. The UE may receive the CSI-RS and determine a precoder. The UE may determine whether enableNonOrthogonalSDBasis in the RRC configuration is true. If enableNonOrthogonalSDBasis is set as true, the UE may determine L DFT basis vectors from SD non-orthogonal basis vector and determine i_{1,2}. If enableNonOrthogonalSDBasis is set as false, the UE may determine L DFT basis vectors from SD orthogonal basis vector and determine i_{1,1} and i_{1,2}. The UE may determine whether enableNonOrthogonalFDBasis in the RRC configuration is true. If enableNonOrthogonalFDBasis is set as true, the UE may determine M DFT basis vectors per layer from FD non-orthogonal basis vector and determine i_{1,6,l}. If enableNonOrthogonalFDBasis is set as false, the UE may determine M DFT basis vectors per layer from FD orthogonal basis vector and determine i_{1,3} and i_{1,6,l}. The UE may determine whether enableNonOrthogonalTDBasis in the RRC configuration is true. If enableNonOrthogonalTDBasis is set as true, the UE may determine Q DFT basis vectors per layer from TD non-orthogonal basis vector and determine i_{1,10,1}. If enableNonOrthogonalTDBasis is set as false, the UE may determine Q DFT basis vectors per layer from TD orthogonal basis vector and determine i_{1,4} and i_{1,10,l}. The UE may report i₁ and i₂. The network node may determine the SD basis vector, the FD basis vector and the precoder.

In some embodiments, the UE may compress a coefficient bitmap and transmit the compressed coefficient bitmap to the network node. More specifically, regarding 3GPP eTypeII precoder, a bitmap size may be required to indicate that the selected coefficients through i_{1,7,l} is 2 LM. The bitmap size may increase as higher L, M and may be independent of the number of non-zero coefficients selected. Therefore, compressing the bitmap size overhead to decrease the overhead for higher L, M,

$${K}_{l}^{NZ}$$

may be introduced.

Different from: (1) reporting a separate bitmap of size 2 LM for each layer l in i_{1,7,l}; and (2) bit value of 1 or

$${k}_{l , i , f}^{( 3 )} = 1$$

corresponding to the selected coefficient in the reported bitmap, indices of locations in the bitmap which corresponds to

$${k}_{l , i , f}^{( 3 )} = 1$$

may be reported.

For example, when L=2, M=2, total number of coefficients possible or bitmap size is 8 per layer, of which if

$${K}_{l}^{NZ} = 2$$

coefficients are selected. Then two indices in the range {0, 1, . . . , 7} which corresponds to the indices of selected coefficients are reported. Since there are C(8,2)=28 ways possible for selecting 2 out of 8 coefficients, a number in the range {0, 1, . . . , 27} which maps to the selected combination is reported. Accordingly, it may only require [log₂(28)]=5 bits instead of reporting entire bitmap which requires 8 bits.

In some implementations, regarding precoder reporting of 3GPP eTypeII precoder, the following procedure may be performed:
for all the

$${K}_{l}^{NZ}$$

non-zero coefficients for which

$${k}_{l , i , f}^{( 3 )} = 1 ,$$

calculate the index d_{l,k}=i_{l,k}*M+f_{l,k} where

$$k ∈ \{ 0 , 1 , … , {K}_{l}^{NZ} - 1 \} ,$$

i∈{0, 1, . . . , 2L−1} and f∈{0, 1, . . . , M−1}.

Then the value d_{l,k} may be reported by using

$${i}_{1 , 7 , l} ∈ \{ 0 , 1 , … , ( \begin{matrix}2 L M \\ {K}_{l}^{N Z}\end{matrix} ) - 1 \}$$

and using the following procedure:
re-arrange d_{l,k} such that d_{l,k} may increase as k increases;
then,

$${i}_{1 , 7 , l} = {\sum }_{k = 0}^{{K}_{l}^{NZ} - 1} ( \begin{matrix}2 LM - 1 - {d}_{l , k} \\ {K}_{l}^{NZ} - k\end{matrix} ) .$$

In some implementations, regarding precoder reconstruction of 3GPP eTypeII precoder, the following procedure may be performed:
the values of i_{l,k}, f_{l,k} may be retrieved from i_{1,7,l} by using the following procedure:

$${s}_{- 1} = 0 for k = 0 , 1 , … , {K}_{l}^{N Z} - 1$$

find the largest

$${x}^{*} ∈ \{ {K}_{l}^{NZ} - 1 - k , … , 2 LM - 1 - k \}$$

such that i_{1,7,l}−sₖ₋₁≥

$$C ( {x}^{*} , {K}_{l}^{NZ} - k )$$

$${e}_{f} = C ( {x}^{*} , {K}_{l}^{NZ} - k )$$

$${s}_{f} = {s}_{f - 1} + {e}_{f}$$

$${d}_{l , k} = 2 LM - 1 - {x}^{*}$$

$${f}_{l , k} = {d}_{l , k} mod M$$

$${i}_{l , k} = \frac{{d}_{l , k} - {f}_{l , k}}{M} .$$

In some implementations, regarding UCI Bit Width Calculation of 3GPP eTypeII precoder, the bit width may be

$$⌈ {log}_{2} ( C ( 2 LM , {K}_{l}^{NZ} ) ) ⌉$$

bits.

In some embodiments, the configuration may be included in the RRC configuration, and may include: (1) a plurality of first parameters for the UE to determine the CSI report including the information of the plurality of non-orthogonal basis vectors; and/or (2) a plurality of second parameters for the UE to determine a frequency oversampling factor, a frequency oversampling offset, a time over sampling factor and a time oversampling offset of the plurality of oversampling factors; and/or (3) a plurality of third parameters for the UE to determine a composite spatial domain and frequency domain basis vector and to determine a value of number of basis vectors selected for composite; and/or (4) e for the UE to determine a common frequency domain basis vector and a common time domain basis vector for all layers. More specifically, all the parameters introduced in the mentioned embodiments may be configured by the network node, and the UE may apply at least part of these parameters based on different scenarios.

In some implementations, the configuration may include the plurality of second parameters. The plurality of second parameters may include a frequency oversampling parameter and a time oversampling parameter. The UE may determine the frequency oversampling factor and the frequency oversampling offset according to the frequency oversampling parameter. The UE may determine the time oversampling factor and the time oversampling offset according to the time oversampling parameter. The UE may transmit the frequency oversampling factor, the frequency oversampling offset, the time oversampling factor and the time oversampling offset to the network node for the network node to determine a FD basis vector and a TD basis vector according to the frequency oversampling factor, frequency oversampling offset, time oversampling factor and the time oversampling offset.

### Illustrative Implementations

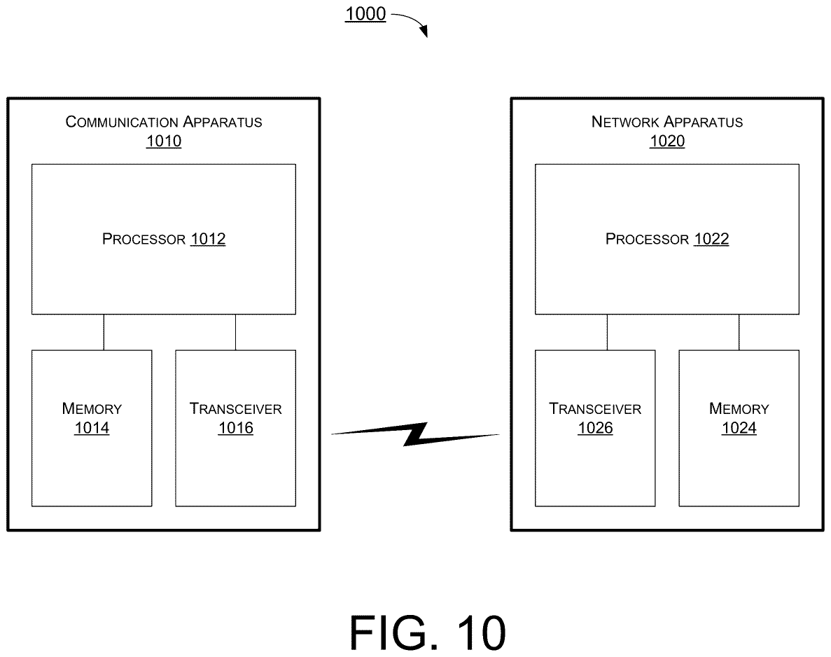

FIG. 10 illustrates an example communication system 1000 having an example communication apparatus 1010 and an example network apparatus 1020 in accordance with an implementation of the present disclosure. Each of communication apparatus 1010 and network apparatus 1020 may perform various functions to implement schemes, techniques, processes and methods described herein pertaining to DL precoder construction with non-orthogonal basis with respect to UE and network apparatus in mobile communications, including scenarios/schemes described above as well as process 1100 and 1200 described below.

Communication apparatus 1010 may be a part of an electronic apparatus, which may be a UE such as a portable or mobile apparatus, a wearable apparatus, a wireless communication apparatus or a computing apparatus. For instance, communication apparatus 1010 may be implemented in a smartphone, a smartwatch, a personal digital assistant, a digital camera, or a computing equipment such as a tablet computer, a laptop computer or a notebook computer. Communication apparatus 1010 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1010 may be implemented in a smart thermostat, a smart fridge, a smart door lock, a wireless speaker or a home control center. Alternatively, communication apparatus 1010 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1010 may include at least some of those components shown in FIG. 10 such as a processor 1012, for example. Communication apparatus 1010 may further include one or more other components not pertinent to the proposed scheme of the present disclosure (e.g., internal power supply, display device and/or user interface device), and, thus, such component(s) of communication apparatus 1010 are neither shown in FIG. 10 nor described below in the interest of simplicity and brevity.

Network apparatus 1020 may be a part of a network apparatus, which may be a network node such as a satellite, a base station, a small cell, a router or a gateway. For instance, network apparatus 1020 may be implemented in an eNodeB in an LTE network, in a gNB in a 5G/NR, IoT, NB-IoT or IIoT network or in a satellite or base station in a 6G network. Alternatively, network apparatus 1020 may be implemented in the form of one or more IC chips such as, for example and without limitation, one or more single-core processors, one or more multi-core processors, or one or more RISC or CISC processors. Network apparatus 1020 may include at least some of those components shown in FIG. 10 such as a processor 1022, for example. Network apparatus 1020 may further include one or more other components not pertinent to the proposed scheme of the present disclosure (e.g., internal power supply, display device and/or user interface device), and, thus, such component(s) of network apparatus 1020 are neither shown in FIG. 10 nor described below in the interest of simplicity and brevity.

In one aspect, each of processor 1012 and processor 1022 may be implemented in the form of one or more single-core processors, one or more multi-core processors, or one or more CISC processors. That is, even though a singular term “a processor” is used herein to refer to processor 1012 and processor 1022, each of processor 1012 and processor 1022 may include multiple processors in some implementations and a single processor in other implementations in accordance with the present disclosure. In another aspect, each of processor 1012 and processor 1022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1012 and processor 1022 is a special-purpose machine specifically designed, arranged and configured to perform specific tasks including autonomous reliability enhancements in a device (e.g., as represented by communication apparatus 1010) and a network (e.g., as represented by network apparatus 1020) in accordance with various implementations of the present disclosure.

In some implementations, communication apparatus 1010 may also include a transceiver 1016 coupled to processor 1012 and capable of wirelessly transmitting and receiving data. In some implementations, communication apparatus 1010 may further include a memory 1014 coupled to processor 1012 and capable of being accessed by processor 1012 and storing data therein. In some implementations, network apparatus 1020 may also include a transceiver 1026 coupled to processor 1022 and capable of wirelessly transmitting and receiving data. In some implementations, network apparatus 1020 may further include a memory 1024 coupled to processor 1022 and capable of being accessed by processor 1022 and storing data therein. Accordingly, communication apparatus 1010 and network apparatus 1020 may wirelessly communicate with each other via transceiver 1016 and transceiver 1026, respectively. To aid better understanding, the following description of the operations, functionalities and capabilities of each of communication apparatus 1010 and network apparatus 1020 is provided in the context of a mobile communication environment in which communication apparatus 1010 is implemented in or as a communication apparatus or a UE and network apparatus 1020 is implemented in or as a network node of a communication network.

In some implementations, processor 1022 may transmit, by the transceiver 1026, a configuration to the communication apparatus 1010 for the communication apparatus 1010 to determine a CSI report including information of a plurality of non-orthogonal basis vectors with a plurality of oversampling factors. Processor 1022 may receive, by the transceiver 1026, the CSI report from the communication apparatus 1010. Processor 1022 may determine a precoder for data transmission according to the information of the plurality of non-orthogonal basis vectors with the plurality of oversampling factors.

In some implementations, the non-orthogonal basis vectors may include a combination of one or more SD basis vectors, one or more FD basis vectors and one or more TD basis vectors.

In some implementations, the configuration may be included in an RRC configuration. The configuration may include: (1) a plurality of first parameters for the communication apparatus 1010 to determine the CSI report including the information of the plurality of non-orthogonal basis vectors; and/or (2) a plurality of second parameters for the communication apparatus 1010 to determine a frequency oversampling offset and a time oversampling offset of the plurality of oversampling factors; and/or (3) a plurality of third parameters for the communication apparatus 1010 to determine a composite SD and FD basis vector and to determine a value of number of basis vectors selected for composite; and/or (4) a plurality of fourth parameters for the communication apparatus 1010 to determine a common FD basis vector and a common TD basis vector for all layers.

In some implementations, the configuration may include the plurality of second parameters. The plurality of second parameters may include a frequency oversampling parameter, a time oversampling parameter, a value of a frequency oversampling factor and a value of a time oversampling factor. Processor 1022 may receive, by the transceiver 1026, the frequency oversampling offset and the time oversampling offset from the communication apparatus 1010. The frequency oversampling offset may be determined by the communication apparatus 1010 according to the frequency oversampling parameter and the value of the frequency oversampling parameter. The time oversampling offset may be determined by the communication apparatus 1010 according to the time oversampling parameter and the value of the time oversampling parameter. Processor 1022 may determine a FD basis vector and a TD basis vector according to the frequency oversampling offset and the time oversampling offset.

In some implementations, the configuration may include the plurality of fourth parameters. The plurality of fourth parameters may include a common FD basis vector parameter and a common TD basis vector parameter. Processor 1022 may receive, by the transceiver 1026, a plurality of first DFT vectors and a plurality of second DFT vectors from the communication apparatus 1010. The plurality of first DFT vectors may be determined by the communication apparatus 1010 according to the common FD basis vector parameter. The plurality of second DFT vectors may be determined by the communication apparatus 1010 according to common TD basis vector parameter. Processor 1022 may determine a FD basis vector and a TD basis vector according to the plurality of first DFT vectors and the plurality of second DFT vectors.

In some implementations, the configuration may include the plurality of first parameters and the plurality of the second parameters. The plurality of first parameters may include a non-orthogonal SD basis vector parameter and a non-orthogonal FD basis vector parameter. The plurality of the second parameters may include a value of a frequency oversampling factor. Processor 1022 may receive, by the transceiver 1026, a plurality of first non-orthogonal DFT vectors and a plurality of second non-orthogonal DFT vectors from the communication apparatus 1010. The plurality of first non-orthogonal DFT vectors may be for SD compression for all layers and determined by the communication apparatus 1010 according to the non-orthogonal SD basis vector parameter. The plurality of second non-orthogonal DFT vectors may be for FD compression per layer and determined by the communication apparatus 1010 according to the non-orthogonal FD basis vector parameter and the value of the frequency oversampling factor. Processor 1022 may determine the precoder according to the plurality of first non-orthogonal DFT vectors and the plurality of second non-orthogonal DFT vectors.

In some implementations, the configuration may include the plurality of first parameters, the plurality of second parameters and the plurality of fourth parameters. The plurality of first parameters may include a non-orthogonal SD basis vector parameter and a non-orthogonal FD basis vector parameter. The plurality of the second parameter may include a frequency oversampling parameter and a value of a frequency oversampling factor. The plurality of fourth parameters may include a common FD basis vector parameter and a common FD offset parameter.

Processor 1022 may receive, by the transceiver 1026, a plurality of first non-orthogonal DFT vectors and a plurality of second non-orthogonal DFT vectors from the communication apparatus 1010. The plurality of first non-orthogonal DFT vectors may be for SD compression for all layers and determined by the communication apparatus 1010 according to the non-orthogonal SD basis vector parameter. The plurality of second non-orthogonal DFT vectors may be for FD compression for all layers and determined by the communication apparatus 1010 according to the non-orthogonal FD basis vector parameter, the frequency oversampling parameter, the value of the frequency oversampling factor, the common FD basis vector parameter and the common FD offset parameter. Processor 1022 may determine the precoder according to the plurality of first non-orthogonal DFT vectors and the plurality of second non-orthogonal DFT vectors.

In some implementations, the configuration may include the plurality of first parameters, the plurality of second parameters and the plurality of third parameters. The plurality of first parameters may include a non-orthogonal SD basis vector parameter and a non-orthogonal FD basis vector parameter. The plurality of second parameters may include a frequency oversampling parameter and a value of a frequency oversampling factor. The plurality of third parameters may include a composite SD and FD basis vector parameter. Processor 1022 may receive, by the transceiver 1026, a plurality of composite vectors from the communication apparatus 1010. The plurality of composite vectors may be composite of non-orthogonal SD basis vectors and non-orthogonal FD basis vectors and determined by the communication apparatus 1010 according to the composite SD and FD basis vector parameter, the non-orthogonal SD basis vector parameter, the non-orthogonal FD basis vector parameter, the frequency oversampling parameter and the value of the frequency oversampling factor. Processor 1022 may determine the precoder according to the plurality of composite vectors.

In some implementations, the configuration may include the plurality of first parameters and the plurality of second parameters. The plurality of first parameters may include a non-orthogonal SD basis vector parameter, a non-orthogonal FD basis vector parameter and a non-orthogonal TD basis vector parameter. The plurality of the second parameters may include a frequency oversampling factor and a time oversampling factor. Processor 1022 may receive, by the transceiver 1026, a plurality of first non-orthogonal DFT vectors, a plurality of second non-orthogonal DFT vectors and a plurality of third non-orthogonal DFT vectors from the communication apparatus 1010. The plurality of first non-orthogonal DFT vectors may be for SD compression for all layers and determined by the communication apparatus 1010 according to the non-orthogonal SD basis vector parameter. The plurality of second non-orthogonal DFT vectors may be for FD compression per layer and determined by the communication apparatus 1010 according to the non-orthogonal FD basis vector parameter and a value of the frequency oversampling factor. The plurality of third non-orthogonal DFT vectors may be for TD compression per layer and determined by the communication apparatus 1010 according to the non-orthogonal TD basis vector parameter and a value of the time oversampling factor. Processor 1022 may determine the precoder according to the plurality of first non-orthogonal DFT vectors, the plurality of second non-orthogonal DFT vectors and the plurality of third non-orthogonal DFT vectors.

In some implementations, processor 1022 may receive, by the transceiver 1026, a coefficient bitmap from the communication apparatus 1010. The communication apparatus 1010 may compress the coefficient bitmap before transmission.

In some implementations, processor 1012 may receive, by the transceiver 1016, a configuration from the network apparatus 1020. Processor 1012 may determine a CSI report including information of a plurality of non-orthogonal basis vectors with a plurality of oversampling factors according to the configuration. Processor 1012 may transmit, by the transceiver 1016, the CSI report to the network apparatus 1020 for the network apparatus 1020 to determine a precoder according to the information of the plurality of non-orthogonal basis vectors with the plurality of oversampling factors.

In some implementations, the non-orthogonal basis vectors may include a combination of one or more SD basis vectors, one or more FD basis vectors and one or more TD basis vectors.

In some implementations, the configuration may be included in an RRC configuration. The configuration may include: (1) a plurality of first parameters for the communication apparatus 1010 to determine the CSI report including the information of the plurality of non-orthogonal basis vectors; and/or (2) a plurality of second parameters for the communication apparatus 1010 to determine a frequency oversampling offset and a time oversampling offset of the plurality of oversampling factors; and/or (3) a plurality of third parameters for the communication apparatus 1010 to determine a composite SD and FD basis vector and to determine a value of number of basis vectors selected for composite; and/or (4) a plurality of fourth parameters for the communication apparatus 1010 to determine a common FD basis vector and a common TD basis vector for all layers.

In some implementations, the configuration may include the plurality of second parameters. The plurality of second parameters may include a frequency oversampling parameter, a time oversampling parameter, a value of the frequency oversampling parameter and a value of the time oversampling parameter. Processor 1012 may determine the frequency oversampling offset according to the frequency oversampling parameter and the value of the frequency oversampling parameter. Processor 1012 may determine the time oversampling offset according to the time oversampling parameter and the value of the time oversampling parameter. Processor 1012 may transmit, by the transceiver 1016, the frequency oversampling offset and the time oversampling offset to the network apparatus 1020 for the network apparatus 1020 to determine a FD basis vector and a TD basis vector according to the frequency oversampling offset and the time oversampling offset.

In some implementations, the configuration may include the plurality of fourth parameters. The plurality of fourth parameters may include a common FD basis vector parameter and a common TD basis vector parameter. Processor 1012 may determine a plurality of first DFT vectors according to the common FD basis vector parameter. Processor 1012 may determine a plurality of second DFT vectors according to common TD basis vector parameter. Processor 1012 may transmit, by the transceiver 1016, the plurality of first DFT vectors and the plurality of second DFT vectors to the network apparatus 1020 for the network apparatus 1020 to determine a FD basis vector and a TD basis vector according to the plurality of first DFT vectors and the plurality of second DFT vectors.

In some implementations, the configuration may include the plurality of first parameters and the plurality of the second parameters. The plurality of first parameters may include a non-orthogonal. The plurality of the second parameters may include a value of a frequency oversampling factor. Processor 1012 may determine a plurality of first non-orthogonal DFT vectors for SD compression for all layers according to the non-orthogonal SD basis vector parameter. Processor 1012 may determine a plurality of second non-orthogonal DFT vectors for FD compression per layer according to the non-orthogonal FD basis vector parameter and the value of the frequency oversampling factor. Processor 1012 may transmit, by the transceiver 1016, the plurality of first non-orthogonal DFT vectors and the plurality of second non-orthogonal DFT vectors to the network apparatus 1020 for the network apparatus 1020 to determine the precoder according to the plurality of first non-orthogonal DFT vectors and the plurality of second non-orthogonal DFT vectors.

In some implementations, the configuration may include the plurality of first parameters, the plurality of second parameters and the plurality of fourth parameters. The plurality of first parameters may include a non-orthogonal SD basis vector parameter and a non-orthogonal FD basis vector parameter. The plurality of the second parameter may include a frequency oversampling parameter and a value of a frequency oversampling factor. The plurality of fourth parameters may include a common FD basis vector parameter and a common FD offset parameter. Processor 1012 may determine a plurality of first non-orthogonal DFT vectors for SD compression for all layers according to the non-orthogonal SD basis vector parameter. Processor 1012 may determine a plurality of second non-orthogonal DFT vectors for FD compression for all layers according to the non-orthogonal FD basis vector parameter, the frequency oversampling parameter, the value of the frequency oversampling factor, the common FD basis vector parameter and the common FD offset parameter. Processor 1012 may transmit, by the transceiver 1016, the plurality of first non-orthogonal DFT vectors and the plurality of second non-orthogonal DFT vectors to the network apparatus 1020 for the network apparatus 1020 to determine the precoder according to the plurality of first non-orthogonal DFT vectors and the plurality of second non-orthogonal DFT vectors.

In some implementations, the configuration may include the plurality of first parameters, the plurality of second parameters and the plurality of third parameters. The plurality of first parameters may include a non-orthogonal SD basis vector parameter and a non-orthogonal FD basis vector parameter. The plurality of second parameters may include a frequency oversampling parameter and a value of a frequency oversampling factor. The plurality of third parameters may include a composite SD and FD basis vector parameter. Processor 1012 may determine a plurality of composite vectors which is composite of non-orthogonal SD basis vectors and non-orthogonal FD basis vectors according to the composite SD and FD basis vector parameter, the non-orthogonal SD basis vector parameter, the non-orthogonal FD basis vector parameter, the frequency oversampling parameter and the value of the frequency oversampling factor. Processor 1012 may transmit, by the transceiver 1016, the plurality of composite vectors to the network apparatus 1020 for the network apparatus 1020 to determine the precoder according to the plurality of composite vectors.

In some implementations, the configuration may include the plurality of first parameters and the plurality of second parameters. The plurality of first parameters may include a non-orthogonal SD basis vector parameter, a non-orthogonal FD basis vector parameter and a non-orthogonal TD basis vector parameter. The plurality of the second parameters may include a frequency oversampling factor and a time oversampling factor. Processor 1012 may determine a plurality of first non-orthogonal DFT vectors for SD compression for all layers according to the non-orthogonal SD basis vector parameter. Processor 1012 may determine a plurality of second non-orthogonal DFT vectors for FD compression per layer according to the non-orthogonal FD basis vector parameter and a value of the frequency oversampling factor. Processor 1012 may determine a plurality of third non-orthogonal DFT vectors for TD compression per layer according to the non-orthogonal TD basis vector parameter and a value of the time oversampling factor. Processor 1012 may transmit, by the transceiver 1016, the plurality of first non-orthogonal DFT vectors, the plurality of second non-orthogonal DFT vectors and the plurality of third non-orthogonal DFT vectors to the network apparatus 1020 for the network apparatus 1020 to determine the precoder according to the plurality of first non-orthogonal DFT vectors, the plurality of second non-orthogonal DFT vectors and the plurality of third non-orthogonal DFT vectors.

In some implementations, the configuration may be included in an RRC configuration. The configuration may include: (1) a plurality of first parameters for the communication apparatus 1010 to determine the CSI report including the information of the plurality of non-orthogonal basis vectors; and/or (2) a plurality of second parameters for the communication apparatus 1010 to determine a frequency oversampling factor, a frequency oversampling offset, a time over sampling factor and a time oversampling offset of the plurality of oversampling factors; and/or (3) a plurality of third parameters for the communication apparatus 1010 to determine a composite SD and FD basis vector and to determine a value of number of basis vectors selected for composite; and/or (4) a plurality of fourth parameters for the communication apparatus 1010 to determine a common FD basis vector and a common TD basis vector for all layers.

In some implementations, the configuration may include the plurality of second parameters. The plurality of second parameters may include a frequency oversampling parameter and a time oversampling parameter. Processor 1012 may determine the frequency oversampling factor and the frequency oversampling offset according to the frequency oversampling parameter. Processor 1012 may determine the time oversampling factor and the time oversampling offset according to the time oversampling parameter. Processor 1012 may transmit, by the transceiver 1016, the frequency oversampling factor, the frequency oversampling offset, the time oversampling factor and the time oversampling offset to the network apparatus 1020 for the network apparatus 1020 to determine a FD basis vector and a TD basis vector according to the frequency oversampling factor, frequency oversampling offset, time oversampling factor and the time oversampling offset.

In some implementations, processor 1012 may compress a coefficient bitmap. Processor 1012 may transmit, by the transceiver 1016, the coefficient bitmap to the network apparatus 1020.

### Illustrative Processes

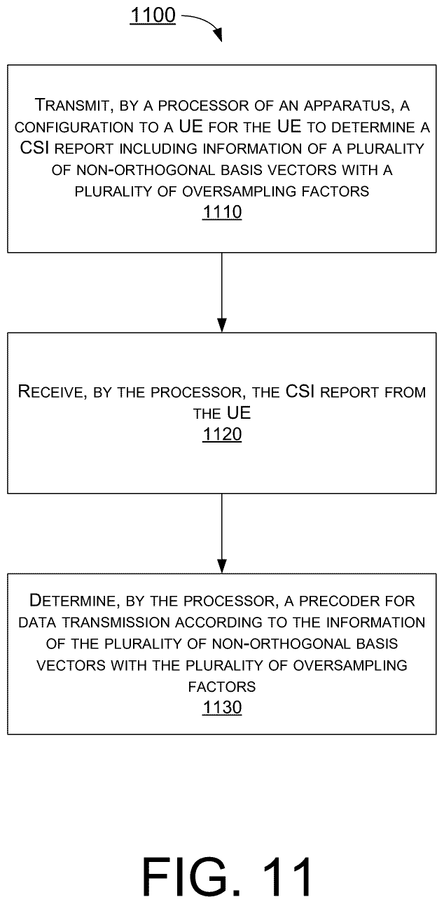

FIG. 11 illustrates an example process 1100 in accordance with an implementation of the present disclosure. Process 1100 may be an example implementation of above scenarios/schemes, whether partially or completely, with respect to DL precoder construction with non-orthogonal basis of the present disclosure. Process 1100 may represent an aspect of implementation of features of network apparatus 1020. Process 1100 may include one or more operations, actions, or functions as illustrated by one or more of blocks 1110 to 1130. Although illustrated as discrete blocks, various blocks of process 1100 may be divided into additional blocks, combined into fewer blocks, or eliminated, depending on the desired implementation. Moreover, the blocks of process 1100 may be executed in the order shown in FIG. 11 or, alternatively, in a different order. Process 1100 may be implemented by network apparatus 1020 or any suitable network device or machine type devices. Solely for illustrative purposes and without limitation, process 1100 is described below in the context of network apparatus 1020. Process 1100 may begin at block 1110.

At block 1110, process 1100 may involve processor 1022 of network apparatus 1020 transmitting a configuration to a UE for the UE to determine a CSI report including information of a plurality of non-orthogonal basis vectors with a plurality of oversampling factors. Process 1100 may proceed from block 1110 to block 1120.

At block 1120, process 1100 may involve processor 1022 receiving the CSI report from the UE. Process 1100 may proceed from block 1120 to block 1130.

At block 1130, process 1100 may involve processor 1022 determine a precoder for data transmission according to the information of the plurality of non-orthogonal basis vectors with the plurality of oversampling factors.

In some implementations, the non-orthogonal basis vectors may include a combination of one or more SD basis vectors, one or more FD basis vectors and one or more TD basis vectors.

In some implementations, the configuration may be included in an RRC configuration. The configuration may include: (1) a plurality of first parameters for the UE to determine the CSI report including the information of the plurality of non-orthogonal basis vectors; and/or (2) a plurality of second parameters for the UE to determine a frequency oversampling offset and a time oversampling offset of the plurality of oversampling factors; and/or (3) a plurality of third parameters for the UE to determine a composite SD and FD basis vector and to determine a value of number of basis vectors selected for composite; and/or (4) a plurality of fourth parameters for the UE to determine a common FD basis vector and a common TD basis vector for all layers.

In some implementations, the configuration may include the plurality of second parameters. The plurality of second parameters may include a frequency oversampling parameter, a time oversampling parameter, a value of the frequency oversampling parameter and a value of the time oversampling parameter. Process 1100 may involve processor 1022 receiving the frequency oversampling offset and the time oversampling offset from the UE. The frequency oversampling offset may be determined by the UE according to the frequency oversampling parameter and the value of the frequency oversampling parameter. The time oversampling offset may be determined by the UE according to the time oversampling parameter and the value of the time oversampling parameter. Process 1100 may involve processor 1022 determining a FD basis vector and a TD basis vector according to the frequency oversampling offset and the time oversampling offset.

In some implementations, the configuration may include the plurality of fourth parameters. The plurality of fourth parameters may include a common FD basis vector parameter and a common TD basis vector parameter. Process 1100 may involve processor 1022 receiving a plurality of first DFT vectors and a plurality of second DFT vectors from the UE. The plurality of first DFT vectors may be determined by the UE according to the common FD basis vector parameter. The plurality of second DFT vectors may be determined by the UE according to common TD basis vector parameter. Process 1100 may involve processor 1022 determining a FD basis vector and a TD basis vector according to the plurality of first DFT vectors and the plurality of second DFT vectors.

In some implementations, the configuration may include the plurality of first parameters and the plurality of the second parameters. The plurality of first parameters may include a non-orthogonal SD basis vector parameter and a non-orthogonal FD basis vector parameter. The plurality of the second parameters may include a value of a frequency oversampling factor. Process 1100 may involve processor 1022 receiving a plurality of first non-orthogonal DFT vectors and a plurality of second non-orthogonal DFT vectors from the UE. The plurality of first non-orthogonal DFT vectors may be for SD compression for all layers and determined by the UE according to the non-orthogonal SD basis vector parameter. The plurality of second non-orthogonal DFT vectors may be for FD compression per layer and determined by the UE according to the non-orthogonal FD basis vector parameter and the value of the frequency oversampling factor. Process 1100 may involve processor 1022 determining the precoder according to the plurality of first non-orthogonal DFT vectors and the plurality of second non-orthogonal DFT vectors.

In some implementations, the configuration may include the plurality of first parameters, the plurality of second parameters and the plurality of fourth parameters. The plurality of first parameters may include a non-orthogonal SD basis vector parameter and a non-orthogonal FD basis vector parameter. The plurality of the second parameter may include a frequency oversampling parameter and a value of a frequency oversampling factor. The plurality of fourth parameters may include a common FD basis vector parameter and a common FD offset parameter. Process 1100 may involve processor 1022 receiving a plurality of first non-orthogonal DFT vectors and a plurality of second non-orthogonal DFT vectors from the UE. The plurality of first non-orthogonal DFT vectors may be for SD compression for all layers and determined by the UE according to the non-orthogonal SD basis vector parameter. The plurality of second non-orthogonal DFT vectors may be for FD compression for all layers and determined by the UE according to the non-orthogonal FD basis vector parameter, the frequency oversampling parameter, the value of the frequency oversampling factor, the common FD basis vector parameter and the common FD offset parameter. Process 1100 may involve processor 1022 determining the precoder according to the plurality of first non-orthogonal DFT vectors and the plurality of second non-orthogonal DFT vectors.

In some implementations, the configuration may include the plurality of first parameters, the plurality of second parameters and the plurality of third parameters. The plurality of first parameters may include a non-orthogonal SD basis vector parameter and a non-orthogonal FD basis vector parameter. The plurality of second parameters may include a frequency oversampling parameter and a value of a frequency oversampling factor. The plurality of third parameters may include a composite SD and FD basis vector parameter. Process 1100 may involve processor 1022 receiving a plurality of composite vectors from the UE. The plurality of composite vectors may be composite of non-orthogonal SD basis vectors and non-orthogonal FD basis vectors and determined by the UE according to the composite SD and FD basis vector parameter, the non-orthogonal SD basis vector parameter, the non-orthogonal FD basis vector parameter, the frequency oversampling parameter and the value of the frequency oversampling factor. Process 1100 may involve processor 1022 determining the precoder according to the plurality of composite vectors.

In some implementations, the configuration may include the plurality of first parameters and the plurality of second parameters. The plurality of first parameters may include a non-orthogonal SD basis vector parameter, a non-orthogonal FD basis vector parameter and a non-orthogonal TD basis vector parameter. The plurality of the second parameters may include a frequency oversampling factor and a time oversampling factor. Process 1100 may involve processor 1022 receiving a plurality of first non-orthogonal DFT vectors, a plurality of second non-orthogonal DFT vectors and a plurality of third non-orthogonal DFT vectors from the UE. The plurality of first non-orthogonal DFT vectors may be for SD compression for all layers and determined by the UE according to the non-orthogonal SD basis vector parameter. The plurality of second non-orthogonal DFT vectors may be for FD compression per layer and determined by the UE according to the non-orthogonal FD basis vector parameter and a value of the frequency oversampling factor. The plurality of third non-orthogonal DFT vectors may be for TD compression per layer and determined by the UE according to the non-orthogonal TD basis vector parameter and a value of the time oversampling factor. Process 1100 may involve processor 1022 determining the precoder according to the plurality of first non-orthogonal DFT vectors, the plurality of second non-orthogonal DFT vectors and the plurality of third non-orthogonal DFT vectors.

In some implementations, process 1100 may involve processor 1022 receiving a coefficient bitmap from the UE. The UE may compress the coefficient bitmap before transmission.

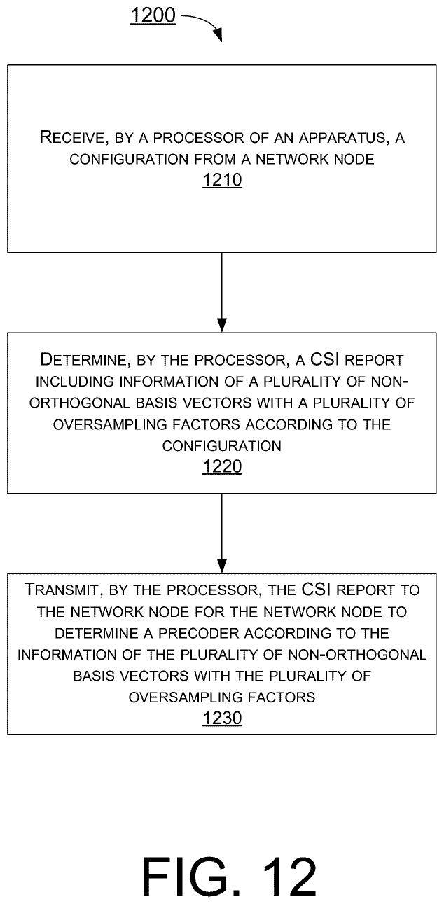

FIG. 12 illustrates an example process 1200 in accordance with an implementation of the present disclosure. Process 1200 may be an example implementation of above scenarios/schemes, whether partially or completely, with respect to DL precoder construction with non-orthogonal basis of the present disclosure. Process 1200 may represent an aspect of implementation of features of communication apparatus 1010. Process 1200 may include one or more operations, actions, or functions as illustrated by one or more of blocks 1210 to 1230. Although illustrated as discrete blocks, various blocks of process 1200 may be divided into additional blocks, combined into fewer blocks, or eliminated, depending on the desired implementation. Moreover, the blocks of process 1200 may be executed in the order shown in FIG. 12 or, alternatively, in a different order. Process 1200 may be implemented by communication apparatus 1010 or any suitable UE or machine type devices. Solely for illustrative purposes and without limitation, process 1200 is described below in the context of communication apparatus 1010. Process 1200 may begin at block 1210.

At block 1210, process 1200 may involve processor 1012 of communication apparatus 1010 receiving a configuration from a network node. Process 1200 may proceed from block 1210 to block 1220.

At block 1220, process 1200 may involve processor 1012 of communication apparatus 1010 determining a CSI report including information of a plurality of non-orthogonal basis vectors with a plurality of oversampling factors according to the configuration. Process 1200 may proceed from block 1220 to block 1230.

At block 1230, process 1200 may involve processor 1012 of communication apparatus 1010 transmitting the CSI report to the network node for the network node to determine a precoder according to the information of the plurality of non-orthogonal basis vectors with the plurality of oversampling factors.

In some implementations, the non-orthogonal basis vectors may include a combination of one or more SD basis vectors, one or more FD basis vectors and one or more TD basis vectors.

In some implementations, the configuration may be included in an RRC configuration. The configuration may include: (1) a plurality of first parameters for processor 1012 of the communication apparatus 1010 to determine the CSI report including the information of the plurality of non-orthogonal basis vectors; and/or (2) a plurality of second parameters for processor 1012 of the communication apparatus 1010 to determine a frequency oversampling offset and a time oversampling offset of the plurality of oversampling factors; and/or (3) a plurality of third parameters for processor 1012 of the communication apparatus 1010 to determine a composite SD and FD basis vector and to determine a value of number of basis vectors selected for composite; and/or (4) a plurality of fourth parameters for processor 1012 of the communication apparatus 1010 to determine a common FD basis vector and a common TD basis vector for all layers.

In some implementations, the configuration may include the plurality of second parameters. The plurality of second parameters may include a frequency oversampling parameter, a time oversampling parameter, a value of the frequency oversampling parameter and a value of the time oversampling parameter. Process 1200 may involve processor 1012 determining the frequency oversampling offset according to the frequency oversampling parameter and the value of the frequency oversampling parameter. Process 1200 may involve processor 1012 determining the time oversampling offset according to the time oversampling parameter and the value of the time oversampling parameter. Process 1200 may involve processor 1012 transmitting the frequency oversampling offset and the time oversampling offset to the network node for the network node to determine a FD basis vector and a TD basis vector according to the frequency oversampling offset and the time oversampling offset.

In some implementations, the configuration may include the plurality of fourth parameters. The plurality of fourth parameters may include a common FD basis vector parameter and a common TD basis vector parameter. Process 1200 may involve processor 1012 determining a plurality of first DFT vectors according to the common FD basis vector parameter. Process 1200 may involve processor 1012 determining a plurality of second DFT vectors according to common TD basis vector parameter. Process 1200 may involve processor 1012 transmitting the plurality of first DFT vectors and the plurality of second DFT vectors to the network node for the network node to determine a FD basis vector and a TD basis vector according to the plurality of first DFT vectors and the plurality of second DFT vectors.

In some implementations, the configuration may include the plurality of first parameters and the plurality of the second parameters. The plurality of first parameters may include a non-orthogonal. The plurality of the second parameters may include a value of a frequency oversampling factor. Process 1200 may involve processor 1012 determining a plurality of first non-orthogonal DFT vectors for SD compression for all layers according to the non-orthogonal SD basis vector parameter. Process 1200 may involve processor 1012 determining a plurality of second non-orthogonal DFT vectors for FD compression per layer according to the non-orthogonal FD basis vector parameter and the value of the frequency oversampling factor. Process 1200 may involve processor 1012 transmitting the plurality of first non-orthogonal DFT vectors and the plurality of second non-orthogonal DFT vectors to the network node for the network node to determine the precoder according to the plurality of first non-orthogonal DFT vectors and the plurality of second non-orthogonal DFT vectors.

In some implementations, the configuration may include the plurality of first parameters, the plurality of second parameter and the plurality of fourth parameters. The plurality of first parameters may include a non-orthogonal SD basis vector parameter and a non-orthogonal FD basis vector parameter. The plurality of the second parameter may include a frequency oversampling parameter and a value of a frequency oversampling factor. The plurality of fourth parameters may include a common FD basis vector parameter and a common FD offset parameter. Process 1200 may involve processor 1012 determining a plurality of first non-orthogonal DFT vectors for SD compression for all layers according to the non-orthogonal SD basis vector parameter. Process 1200 may involve processor 1012 determining a plurality of second non-orthogonal DFT vectors for FD compression for all layers according to the non-orthogonal FD basis vector parameter, the frequency oversampling parameter, the value of the frequency oversampling factor, the common FD basis vector parameter and the common FD offset parameter. Process 1200 may involve processor 1012 transmitting the plurality of first non-orthogonal DFT vectors and the plurality of second non-orthogonal DFT vectors to the network node for the network node to determine the precoder according to the plurality of first non-orthogonal DFT vectors and the plurality of second non-orthogonal DFT vectors.

In some implementations, the configuration may include the plurality of first parameters, the plurality of second parameters and the plurality of third parameters. The plurality of first parameters may include a non-orthogonal SD basis vector parameter and a non-orthogonal FD basis vector parameter. The plurality of second parameters may include a frequency oversampling parameter and a value of a frequency oversampling factor. The plurality of third parameters may include a composite SD and FD basis vector parameter. Process 1200 may involve processor 1012 determining a plurality of composite vectors which is composite of non-orthogonal SD basis vectors and non-orthogonal FD basis vectors according to the composite SD and FD basis vector parameter, the non-orthogonal SD basis vector parameter the non-orthogonal FD basis vector parameter, the frequency oversampling parameter and the value of the frequency oversampling factor. Process 1200 may involve processor 1012 transmitting the plurality of composite vectors to the network node for the network node to determine the precoder according to the plurality of composite vectors.

In some implementations, the configuration may include the plurality of first parameters and the plurality of second parameters. The plurality of first parameters may include a non-orthogonal SD basis vector parameter, a non-orthogonal FD basis vector parameter and a non-orthogonal TD basis vector parameter. The plurality of the second parameters may include a frequency oversampling factor and a time oversampling factor. Process 1200 may involve processor 1012 determining a plurality of first non-orthogonal DFT vectors for SD compression for all layers according to the non-orthogonal SD basis vector parameter. Process 1200 may involve processor 1012 determining a plurality of second non-orthogonal DFT vectors for FD compression per layer according to the non-orthogonal FD basis vector parameter and a value of the frequency oversampling factor. Process 1200 may involve processor 1012 determining a plurality of third non-orthogonal DFT vectors for TD compression per layer according to the non-orthogonal TD basis vector parameter and a value of the time oversampling factor. Process 1200 may involve processor 1012 transmitting the plurality of first non-orthogonal DFT vectors, the plurality of second non-orthogonal DFT vectors and the plurality of third non-orthogonal DFT vectors to the network node for the network node to determine the precoder according to the plurality of first non-orthogonal DFT vectors, the plurality of second non-orthogonal DFT vectors and the plurality of third non-orthogonal DFT vectors.

In some implementations, the configuration may be included in an RRC configuration. The configuration may include: (1) a plurality of first parameters for the UE to determine the CSI report including the information of the plurality of non-orthogonal basis vectors; and/or (2) a plurality of second parameters for the UE to determine a frequency oversampling factor, a frequency oversampling offset, a time over sampling factor and a time oversampling offset of the plurality of oversampling factors; and/or (3) a plurality of third parameters for the UE to determine a composite SD and FD basis vector and to determine a value of number of basis vectors selected for composite; and/or (4) a plurality of fourth parameters for the UE to determine a common FD basis vector and a common TD basis vector for all layers.

In some implementations, the configuration may include the plurality of second parameters. The plurality of second parameters may include a frequency oversampling parameter and a time oversampling parameter. Processor 1012 may determine the frequency oversampling factor and the frequency oversampling offset according to the frequency oversampling parameter. Process 1200 may involve processor 1012 determining the time oversampling factor and the time oversampling offset according to the time oversampling parameter. Process 1200 may involve processor 1012 transmitting the frequency oversampling factor, the frequency oversampling offset, the time oversampling factor and the time oversampling offset to the network node for the network node to determine a FD basis vector and a TD basis vector according to the frequency oversampling factor, frequency oversampling offset, time oversampling factor and the time oversampling offset.

In some implementations, Process 1200 may involve processor 1012 compressing a coefficient bitmap. Process 1200 may involve processor 1012 transmitting the coefficient bitmap to the network node.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, a configuration to a user equipment (UE) for the UE to determine a channel state information (CSI) report including information of a plurality of non-orthogonal basis vectors with a plurality of oversampling factors;
receiving, by the processor, the CSI report from the UE; and
determining, by the processor, a precoder for data transmission according to the information of the plurality of non-orthogonal basis vectors with the plurality of oversampling factors.

2. The method of claim 1, wherein the non-orthogonal basis vectors include a combination of one or more spatial domain basis vectors, one or more frequency domain basis vectors and one or more time domain basis vectors.

3. The method of claim 1, wherein the configuration is included in a radio resource control (RRC) configuration, and includes at least one of:
a plurality of first parameters for the UE to determine the CSI report including the information of the plurality of non-orthogonal basis vectors;
a plurality of second parameters for the UE to determine a frequency oversampling offset and a time oversampling offset of the plurality of oversampling factors;
a plurality of third parameters for the UE to determine a composite spatial domain and frequency domain basis vector and to determine a value of number of basis vectors selected for composite; and
a plurality of fourth parameters for the UE to determine a common frequency domain basis vector and a common time domain basis vector for all layers.

4. The method of claim 3, wherein the configuration includes the plurality of second parameters, the plurality of second parameters includes a frequency oversampling parameter, a time oversampling parameter, a value of a frequency oversampling factor and a value of a time oversampling factor, and the method further comprises:
receiving, by the processor, the frequency oversampling offset and the time oversampling offset from the UE, wherein the frequency oversampling offset is determined by the UE according to the frequency oversampling parameter and the value of the frequency oversampling parameter, wherein the time oversampling offset is determined by the UE according to the time oversampling parameter and the value of the time oversampling parameter; and
determining, by the processor, a frequency domain basis vector and a time domain basis vector according to the frequency oversampling offset and the time oversampling offset.

5. The method of claim 3, wherein the configuration includes the plurality of fourth parameters, the plurality of fourth parameters includes a common frequency domain basis vector parameter and a common time domain basis vector parameter, and the method further comprises:
receiving, by the processor, a plurality of first discrete Fourier transform (DFT) vectors and a plurality of second DFT vectors from the UE, wherein the plurality of first DFT vectors is determined by the UE according to common frequency domain basis vector parameter, wherein the plurality of second DFT vectors is determined by the UE according to common time domain basis vector parameter; and
determining, by the processor, a frequency domain basis vector and a time domain basis vector according to the plurality of first DFT vectors and the plurality of second DFT vectors.

6. The method of claim 3, wherein the configuration includes the plurality of first parameters and the plurality of the second parameters, the plurality of first parameters includes a non-orthogonal spatial domain basis vector parameter and a non-orthogonal frequency domain basis vector parameter, the plurality of the second parameters includes a value of a frequency oversampling factor, and the method further comprises:
receiving, by the processor, a plurality of first non-orthogonal discrete Fourier transform (DFT) vectors and a plurality of second non-orthogonal DFT vectors from the UE, wherein the plurality of first non-orthogonal DFT vectors is for spatial domain compression for all layers and is determined by the UE according to the non-orthogonal spatial domain basis vector parameter, wherein the plurality of second non-orthogonal DFT vectors is for frequency domain compression per layer and is determined by the UE according to the non-orthogonal frequency domain basis vector parameter and the value of the frequency oversampling factor; and
determining, by the processor, the precoder according to the plurality of first non-orthogonal DFT vectors and the plurality of second non-orthogonal DFT vectors.

7. The method of claim 3, wherein the configuration includes the plurality of first parameters, the plurality of second parameters and the plurality of fourth parameters, the plurality of first parameters includes a non-orthogonal spatial domain basis vector parameter and a non-orthogonal frequency domain basis vector parameter, the plurality of the second parameter includes a frequency oversampling parameter and a value of a frequency oversampling factor, the plurality of fourth parameters includes a common frequency domain basis vector parameter and a common frequency domain offset parameter, and the method further comprises:
receiving, by the processor, a plurality of first non-orthogonal discrete Fourier transform (DFT) vectors and a plurality of second non-orthogonal DFT vectors from the UE, wherein the plurality of first non-orthogonal DFT vectors is for spatial domain compression for all layers and is determined by the UE according to the non-orthogonal spatial domain basis vector parameter, wherein the plurality of second non-orthogonal DFT vectors is for frequency domain compression for all layers and is determined by the UE according to the non-orthogonal frequency domain basis vector parameter, the frequency oversampling parameter, the value of the frequency oversampling factor, the common frequency domain basis vector parameter and the common frequency domain offset parameter; and
determining, by the processor, the precoder according to the plurality of first non-orthogonal DFT vectors and the plurality of second non-orthogonal DFT vectors.

8. The method of claim 3, wherein the configuration includes the plurality of first parameters, the plurality of second parameters, the plurality of third parameters and the plurality of fourth parameters, the plurality of first parameters includes a non-orthogonal spatial domain basis vector parameter and a non-orthogonal frequency domain basis vector parameter, the plurality of second parameters includes a frequency oversampling parameter and a value of a frequency oversampling factor, the plurality of third parameters includes a composite spatial and frequency domain basis vector parameter, the plurality of fourth parameters includes a common frequency domain basis vector parameter, and the method further comprises:
receiving, by the processor, a plurality of composite vectors from the UE, wherein the plurality of composite vectors is composite of non-orthogonal spatial domain basis vectors and non-orthogonal frequency domain basis vectors and is determined by the UE according to the composite spatial and frequency domain basis vector parameter, the non-orthogonal spatial domain basis vector parameter, the non-orthogonal frequency domain basis vector parameter, the frequency oversampling parameter and the value of the frequency oversampling factor; and
determining, by the processor, the precoder according to the plurality of composite vectors.

9. The method of claim 3, wherein the configuration includes the plurality of first parameters, the plurality of second parameters, the plurality of first parameters includes a non-orthogonal spatial domain basis vector parameter, a non-orthogonal frequency domain basis vector parameter and a non-orthogonal time domain basis vector parameter, the plurality of the second parameters includes a frequency oversampling factor and a time oversampling factor, and the method further comprises:
receiving, by the processor, a plurality of first non-orthogonal discrete Fourier transform (DFT) vectors, a plurality of second non-orthogonal DFT vectors and a plurality of third non-orthogonal DFT vectors from the UE, wherein the plurality of first non-orthogonal DFT vectors is for spatial domain compression for all layers and is determined by the UE according to the non-orthogonal spatial domain basis vector parameter, wherein the plurality of second non-orthogonal DFT vectors is for frequency domain compression per layer and is determined by the UE according to the non-orthogonal frequency domain basis vector parameter and a value of the frequency oversampling factor, wherein the plurality of third non-orthogonal DFT vectors is for time domain compression per layer and is determined by the UE according to the non-orthogonal time domain basis vector parameter and a value of the time oversampling factor; and
determining, by the processor, the precoder according to the plurality of first non-orthogonal DFT vectors, the plurality of second non-orthogonal DFT vectors and the plurality of third non-orthogonal DFT vectors.

10. The method of claim 1, further comprising:
receiving, by the processor, a coefficient bitmap from the UE, wherein the UE compresses the coefficient bitmap before transmission.

11. A method, comprising:
receiving, by a processor of an apparatus, a configuration from a network node;
determining, by the processor, a channel state information (CSI) report including information of a plurality of non-orthogonal basis vectors with a plurality of oversampling factors according to the configuration; and
transmitting, by the processor, the CSI report to the network node for the network node to determine a precoder according to the information of the plurality of non-orthogonal basis vectors with the plurality of oversampling factors.

12. The method of claim 11, wherein the non-orthogonal basis vectors include a combination of one or more spatial domain basis vectors, one or more frequency domain basis vectors and one or more time domain basis vectors.

13. The method of claim 11, wherein the configuration is included in a radio resource control (RRC) configuration, and includes at least one of:
a plurality of first parameters for the apparatus to determine the CSI report including the information of the plurality of non-orthogonal basis vectors;
a plurality of second parameters for the apparatus to determine a frequency oversampling offset and a time oversampling offset of the plurality of oversampling factors;
a plurality of third parameters for the apparatus to determine a composite spatial domain and frequency domain basis vector and to determine a value of number of basis vectors selected for composite; and
a plurality of fourth parameters for the apparatus to determine a common frequency domain basis vector and a common time domain basis vector for all layers.

14. The method of claim 13, wherein the configuration includes the plurality of second parameters, the plurality of second parameters includes a frequency oversampling parameter, a time oversampling parameter, a value of a frequency oversampling factor and a value of a time oversampling factor, and the method further comprises:
determining, by the processor, the frequency oversampling offset according to the frequency oversampling parameter and the value of the frequency oversampling factor;
determining, by the processor, the time oversampling offset according to the time oversampling parameter and the value of the time oversampling factor; and
transmitting, by the processor, the frequency oversampling offset and the time oversampling offset to the network node for the network node to determine a frequency domain basis vector and a time domain basis vector according to the frequency oversampling offset and the time oversampling offset.

15. The method of claim 13, wherein the configuration includes the plurality of fourth parameters, the plurality of fourth parameters includes a common frequency domain basis vector parameter and a common time domain basis vector parameter, and the method further comprises:
determining, by the processor, a plurality of first discrete Fourier transform (DFT) vectors according to common frequency domain basis vector parameter;
determining, by the processor, a plurality of second DFT vectors according to the common time domain basis vector parameter; and
transmitting, by the processor, the plurality of first DFT vectors and the plurality of second DFT vectors to the network node for the network node to determine a frequency domain basis vector and a time domain basis vector according to the plurality of first DFT vectors and the plurality of second DFT vectors.

16. The method of claim 13, wherein the configuration includes the plurality of first parameters, the plurality of the second parameters, the plurality of first parameters includes a non-orthogonal spatial domain basis vector parameter and a non-orthogonal frequency domain basis vector parameter, the plurality of the second parameters includes a value of a frequency oversampling factor, and the method further comprises:
determining, by the processor, a plurality of first non-orthogonal discrete Fourier transform (DFT) vectors for spatial domain compression for all layers UE according to the non-orthogonal spatial domain basis vector parameter;
determining, by the processor, a plurality of second non-orthogonal DFT vectors for frequency domain compression per layer according to the non-orthogonal frequency domain basis vector parameter and the value of frequency oversampling factor; and
transmitting, by the processor, the plurality of first non-orthogonal DFT vectors and the plurality of second non-orthogonal DFT vectors to the network node for the network node to determine the precoder according to the plurality of first non-orthogonal DFT vectors and the plurality of second non-orthogonal DFT vectors.

17. The method of claim 13, wherein the configuration includes the plurality of first parameters, the plurality of second parameters and the plurality of fourth parameters, the plurality of first parameters includes a non-orthogonal spatial domain basis vector parameter and a non-orthogonal frequency domain basis vector parameter, the plurality of second parameters includes a frequency oversampling parameter, and a value of a frequency oversampling factor, the plurality of fourth parameters includes a common frequency domain basis vector parameter and a common frequency domain offset parameter, and the method further comprises:
determining, by the processor, a plurality of first non-orthogonal discrete Fourier transform (DFT) vectors for spatial domain compression for all layers according to the non-orthogonal spatial domain basis vector parameter;
determining, by the processor, a plurality of second non-orthogonal DFT vectors for frequency domain compression for all layers according to the non-orthogonal frequency domain basis vector parameter, the frequency oversampling parameter, the value of the frequency oversampling factor, the common frequency domain basis vector parameter and the common frequency domain offset parameter; and
transmitting, by the processor, the plurality of first non-orthogonal DFT vectors and the plurality of second non-orthogonal DFT vectors to the network node for the network node to determine the precoder according to the plurality of first non-orthogonal DFT vectors and the plurality of second non-orthogonal DFT vectors.

18. The method of claim 13, wherein the configuration includes the plurality of first parameters, the plurality of second parameters, the plurality of third parameters and the plurality of fourth parameters, the plurality of first parameters includes a non-orthogonal spatial domain basis vector parameter and a non-orthogonal frequency domain basis vector parameter, the plurality of second parameters includes a frequency oversampling parameter and a value of a frequency oversampling factor, the plurality of third parameters includes a composite spatial and frequency domain basis vector parameter, the plurality of fourth parameters includes a common frequency domain basis vector parameter, and the method further comprises:
determining, by the processor, a plurality of composite vectors according to the composite spatial and frequency domain basis vector parameter, the non-orthogonal spatial domain basis vector parameter, the non-orthogonal frequency domain basis vector parameter, the frequency oversampling parameter and the value of frequency oversampling factor, wherein the plurality of composite vectors is composite of non-orthogonal spatial domain basis vectors and non-orthogonal frequency domain basis vectors; and
transmitting, by the processor, the plurality of composite vectors to the network node for the network node to determine the precoder according to the plurality of composite vectors.

19. The method of claim 13, wherein the configuration includes the plurality of first parameters, the plurality of second parameters, the plurality of first parameters includes a non-orthogonal spatial domain basis vector parameter, a non-orthogonal frequency domain basis vector parameter and a non-orthogonal time domain basis vector parameter, the plurality of second parameters include a frequency oversampling factor and a time oversampling factor, and the method further comprises:
determining, by the processor, a plurality of first non-orthogonal discrete Fourier transform (DFT) vectors for spatial domain compression for all layers according to the non-orthogonal spatial domain basis vector parameter;
determining, by the processor, a plurality of second non-orthogonal DFT vectors for frequency domain compression per layer according to the non-orthogonal frequency domain basis vector parameter and the value of the frequency oversampling factor; and
determining, by the processor, a plurality of third non-orthogonal DFT vectors for time domain compression per layer according to the non-orthogonal time domain basis vector parameter and the value of the time oversampling factor; and
transmitting, by the processor, the plurality of first non-orthogonal DFT vectors, the plurality of second non-orthogonal DFT vectors and the plurality of third non-orthogonal DFT vectors to the network node for the network node to determine the precoder according to the plurality of first non-orthogonal DFT vectors, the plurality of second non-orthogonal DFT vectors and the plurality of third non-orthogonal DFT vectors.

20. The method of claim 11, wherein the configuration is included in a radio resource control (RRC) configuration, and includes at least one of:
a plurality of first parameters for the apparatus to determine the CSI report including the information of the plurality of non-orthogonal basis vectors;
a plurality of second parameters for the apparatus to determine a frequency oversampling factor, a frequency oversampling offset, a time over sampling factor and a time oversampling offset of the plurality of oversampling factors;
a plurality of third parameters for the apparatus to determine a composite spatial domain and frequency domain basis vector and to determine a value of number of basis vectors selected for composite; and
a plurality of fourth parameters for the apparatus to determine a common frequency domain basis vector and a common time domain basis vector for all layers.

21. The method of claim 20, wherein the configuration includes the plurality of second parameters, the plurality of second parameters includes a frequency oversampling parameter, a time oversampling parameter, and the method further comprises:
determining, by the processor, the frequency oversampling factor and the frequency oversampling offset according to the frequency oversampling parameter;
determining, by the processor, the time oversampling factor and the time oversampling offset according to the time oversampling parameter; and
transmitting, by the processor, the frequency oversampling factor, the frequency oversampling offset, the time oversampling factor and the time oversampling offset to the network node for the network node to determine a frequency domain basis vector and a time domain basis vector according to the frequency oversampling factor, frequency oversampling offset, time oversampling factor and the time oversampling offset.

22. The method of claim 11, further comprising:
compressing, by the processor, a coefficient bitmap; and
transmitting, by the processor, the coefficient bitmap to the network node.
